(19) United States
(12) Patent Application Publication
(10) Pub. No.: US 2026/0338612 A1
(43) Pub. Date: Oct. 29, 2026

(54) THERMAL MONITORING SYSTEMS

(71) Applicant: Analog Devices International Unlimited Company, Co. Limerick (IE)

(72) Inventors: Ciaran Curtin, Ovens (IE); Edward John Coyne, Athenry (IE); Christopher Magruder, Boston, MA (US); Alan J. O'Donnell, Castletroy (IE); Richard T. Anslow, Limerick (IE); John R. Wallrabenstein, Lafayette, IN (US)

(21) Appl. No.: 19/189,685

(22) Filed: Apr. 25, 2025

(51) Int. Cl. G01K 3/10; G01K 1/02; G01K 1/024; G01K 7/00; H04L 9/32

(52) U.S. Cl. CPC G01K 3/10; G01K 1/024; G01K 1/026; G01K 7/00; H04L 9/3278

(57) ABSTRACT

The present disclosure provides a thermal event monitoring system. Specifically, there is provided a passive thermal sensor configured to detect an occurrence of thermal cycles, and to record a cumulative count of thermal cycles via alteration of an electrical property of the thermal sensor. That is, the thermal sensor detects and records thermal cycles or thermal events without the need for power, by alteration of a physical characteristic that changes a measurable electrical property of the sensor. Each alteration of the electrical property is non-transient, and therefore the record of the cumulative count and/or thermal events does not erase with time. Also provided is a reader that measures the electrical property to generate a signal, which is transmitted by a communication interface to a host controller. The provided system thus enables counting of thermal cycles without the need for continuous power, which may be particularly beneficial for remote monitoring in harsh environments.

### BACKGROUND

### Field of the Invention

The present disclosure generally relates to thermal monitoring systems, and more particularly to systems for monitoring thermal exposure.

### Description of the Related Art

Thermal exposure monitoring systems are required in a large number of industries to determine thermal exposure of components. If components experience excessive or repeated heat exposure, then those components may deteriorate, leading to safety concerns and potential failure of wider systems. Accordingly, monitoring and recording thermal exposure for further analysis and to flag unexpected conditions may be of vital importance.

### SUMMARY

According to a first aspect of the disclosure, there is provided a system for thermal cycle counting. The system comprises a passive thermal sensor configured to detect an occurrence of thermal cycles, and to record a cumulative count of thermal cycles via alteration of an electrical property of the thermal sensor. Each alteration of the electrical property is non-transient. The system also comprises a reader configured to measure the electrical property of the thermal sensor, and to generate a signal based on the measured electrical property. The system further comprises a communication interface configured to transmit the signal to a host controller.

According to a second aspect of the present disclosure, a system for monitoring thermal exposure events is provided. The system comprises a passive thermal sensor configured to detect an occurrence of thermal exposure events, and to record the occurrence of the thermal exposure event via alteration of an electrical property of the thermal sensor. Each alteration of the electrical property is non-transient. The system also comprises a reader configured to measure the electrical property of the thermal sensor, and to generate a signal based on the measured electrical property. In addition, the system comprises a local controller configured to process the signal to generate an encrypted signal. The system further comprises a communication interface configured to transmit the encrypted signal to a host controller for processing the encrypted signal.

Those skilled in the art will recognize additional features and advantages upon reading the following detailed description, and upon viewing the accompanying drawings.

### BRIEF DESCRIPTION OF THE DRAWINGS

Systems will now be described by way of example with reference to the accompanying drawings, in which:

FIG. 1 presents a block diagram of a system for thermal cycle counting and/or thermal exposure event monitoring according to an exemplary embodiment;

FIG. 2 presents a block diagram of a system for thermal cycle counting and/or thermal exposure event monitoring including a local controller according to another embodiment;

FIG. 3 presents a block diagram of a system for thermal cycle counting and/or thermal exposure event monitoring including a processing unit according to a further embodiment;

FIG. 4 presents a block diagram of a system for thermal cycle counting and/or thermal exposure event monitoring including a power harvesting module according to other embodiments;

FIG. 5 presents a block diagram of a system for thermal cycle counting and/or thermal exposure event monitoring including a plurality of sensors according to an embodiment;

FIGS. 6-11 provide various simplified cross-sections of modular systems for thermal cycle counting and/or thermal exposure event monitoring provided in casings;

FIG. 12 represents conversion of thermal cycle inputs into an output response;

FIG. 13 depicts an example of a thermal sensor and conversion of thermal cycle inputs into an output response;

FIG. 14 presents an example of an application of a thermal monitoring system;

FIGS. 15A and 15B present further applications of a thermal monitoring system;

FIG. 16 presents another example application of a thermal monitoring system;

FIG. 17 depicts an additional example of an application of a thermal monitoring system;

FIG. 18 depicts a block diagram of a system for thermal cycle counting;

FIG. 19 depicts a block diagram of a system for monitoring thermal events;

FIG. 20 presents integration and implementation options for the thermal monitoring systems described in relation to FIGS. 18 and 19;

FIG. 21 presents various options for components that may be implemented as part of the various subsystems of FIGS. 18 and 19;

FIGS. 22-27 provide various block diagrams of a thermal monitoring system for a variety of applications; and

FIG. 28 provides a block diagram of a communication interface.

It should be noted that these figures are diagrammatic and not drawn to scale. Relative dimensions and proportions of parts of these figures have been shown exaggerated or reduced in size, for the sake of clarity and convenience in the drawings.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a thermal event monitoring system. According to a first aspect of the disclosure, there is provided a system for thermal cycle counting. The system comprises a passive thermal sensor configured to detect an occurrence of thermal cycles, and to record a cumulative count of thermal cycles via alteration of an electrical property of the thermal sensor. Each alteration of the electrical property is non-transient. The system further comprises a reader configured to measure the electrical property of the thermal sensor, and to generate a signal based on the measured electrical property, and a communication interface configured to transmit the signal to a host controller.

Specifically, there is provided a passive thermal sensor configured to detect an occurrence of thermal cycles, and to record a cumulative count of thermal cycles via alteration of an electrical property of the thermal sensor. That is, the thermal sensor detects and records thermal cycles or thermal events without the need for power, by alteration of a physical characteristic that changes a measurable electrical property of the sensor. Each alteration of the electrical property is non-transient, and therefore the record of the cumulative count and/or thermal events does not erase with time. Also provided is a reader that measures the electrical property to generate a signal, which is transmitted by a communication interface to a host controller. The provided system thus enables counting of thermal cycles without the need for continuous power, which may be particularly beneficial for remote monitoring in harsh environments.

Proposed examples therefore leverage passive thermal sensors, being sensors capable of detecting and recording thermal cycles without requiring power to do so. These thermal sensors count each occurrence of the thermal sensor being exposed to a predetermined temperature range for a predetermined length of time. Accordingly, each time the thermal sensor is exposed to the temperature range for the length of time, an electrical property of the thermal sensor is altered to count the occurrence. This change is non-transient, so that the thermal sensor will not erase the recording. Subsequently, when the reader is provided, the electrical property of the thermal sensor is measured to generate a signal. From the signal, the cumulative count of the thermal cycles can be derived. The signal is transmitted to a host controller, which may perform processing and analysis of the signal.

By virtue of the passive detection, and non-transient recording of the thermal cycles by the system, monitoring of thermal cycles in hard-to-access locations, such as within machinery, is improved. Indeed, the thermal sensor will not require power, which therefore may obviate the need for means required to provide the power, and the thermal sensor may not have to be replaced or maintained as often. In addition, the system may be particularly suited for harsh conditions (for which thermal cycle monitoring may be principally desirable). As the thermal sensor does not require power and records the cumulative count of thermal cycles in a transient manner, there may not be a need for energy storage devices and/or memory storage device which may degrade in said harsh conditions.

Therefore, proposed is a system for thermal cycle counting that may be particularly advantageous for monitoring thermal cycles in harsh conditions, and in location that are difficult to reach.

More specifically, this proposed thermal cycle counting system may be utilized in various applications and environments. In some aspects, such a system may be employed in industrial settings to monitor equipment and machinery to monitor potential deterioration or exposure to unsafe temperatures. The system may be implemented in manufacturing facilities, power plants, or chemical processing plants to detect abnormal temperature fluctuations and alert operators to unexpected temperature conditions or even potential hazards.

In some cases, the thermal cycle counting system may also find applications in transportation sectors. For instance, it may be installed in vehicles, aircraft, or ships to monitor engine compartments, electrical systems, and cargo areas for signs of overheating. This may help prevent accidents and ensure the safety of passengers and crew.

Data centers and server rooms may benefit from the implementation of a thermal event monitoring system. By continuously monitoring temperature distributions across server racks and cooling systems, the system may help maintain optimal operating conditions and prevent equipment damage due to overheating.

The proposed systems may also find applications in the energy sector, such as monitoring solar panel arrays for hotspots that could indicate malfunctioning panels or potential fire hazards. Similarly, it may be used in wind turbines to detect overheating in mechanical components or electrical systems.

Furthermore, the proposed system may be particularly well suited for autoclaving cycle monitoring. Autoclaving involves raising the temperature of medical equipment to a predetermined temperature range for a predetermined amount of time at certain pressures and humidity levels. It is important to track the number of autoclave cycles experienced by medical equipment, as it induces thermal stress and corrosion of medical equipment, limiting the number of safe reuses. In addition, it is important to ensure that the autoclave process has exposed the medical equipment to the correct temperatures for the correct time to ensure adequate sterilization. Accordingly, it is important to track the number of autoclave cycles, as well as the proper execution of the autoclave cycle. The harsh conditions induced by the autoclave cycle could have a negative impact on typical semiconductor sensing electronics and batteries. However, with the proposed passive and non-transient thermal sensor, the need for such electronics and batteries during the autoclave process may be obviated. The proposed system may therefore be particularly suited to monitoring autoclave cycle counting for such medical equipment, both to ensure that the equipment is properly sanitized, and to count the number of times the equipment has undergone autoclaving.

Of course, the above examples should not be considered limiting. Further use-cases would be readily appreciated by the skilled person.

The system is for thermal cycle counting. In other words, there is provided a system that monitors the detects and records the number of times a thermal cycle has occurred. The thermal sensor detects each time a high-temperature peak, and a low-temperature peak are met. In some embodiments, the temperature may have to remain at the high-temperature peak (or within a range of the high-temperature peak) for a certain length of time, before returning to a low-temperature to count as one occurrence of a thermal cycle. The thermal sensor is passive, meaning that it does not require power to operate.

To record this, the passive thermal sensor may have a physical characteristic that changes in response to the occurrence of a thermal cycle, such that an electrical property (e.g., impedance, resistance) of the thermal sensor changes. Accordingly, upon application of the temperatures present in the thermal cycle, the electrical property of the thermal sensor is altered. Over time this electrical property does not change (i.e., is non-transient), unless by application of another thermal cycle, which will alter the electrical property further. Then, by interrogation of the electrical property of the thermal sensor, the cumulative count of thermal cycles detected by the thermal sensor may be deduced.

For this purpose, the system further comprises a reader that can measure the electrical property. That is, a reader unit is provided that may apply a stimulus to determine the electrical property of the passive thermal sensor. The reader converts the measured electrical property into a signal. For example, the reader may extract an analog measurement of the electrical property and convert the analog measurement to a digital signal for further processing. The communication interface then transmits this signal to a host controller, which may be an external controller for processing of the signal to determine the cumulative count of thermal cycles, and to perform further analysis. In other words, the communication interface provides the signal from the reader to the host controller via a wired or wireless connection.

Advantageously, this system may be particularly suited for monitoring thermal cycles in particularly hard-to-reach and harsh conditions (e.g., high temperature, high humidity, and high pressure). Indeed, as the thermal sensor does not require power to detect the thermal cycles nor power to ensure that the count of thermal cycles is recorded in a non-transient manner, the thermal sensor may be placed without the need for power or memory apparatus. Such apparatus may deteriorate in harsh conditions, leading to failure and inaccurate monitoring of the thermal cycles. Further, as the thermal sensor does not require power, it may be placed in hard-to-reach locations for long periods of time without the need for maintenance before being interrogated by the reader. The reader and the communication interface work together to transfer the information regarding the electrical property of the thermal sensor (and thus the cumulative count of thermal cycles) to the host controller for further analysis.

According to a second aspect in accordance with the disclosure, a system for monitoring thermal exposure events is provided. The system comprises a passive thermal sensor configured to detect an occurrence of thermal exposure events, and to record the occurrence of the thermal exposure event via alteration of an electrical property of the thermal sensor. Each alteration of the electrical property is non-transient. The system also comprises a reader configured to measure the electrical property of the thermal sensor, and to generate a signal based on the measured electrical property. In addition, the system comprises a local controller configured to process the signal to generate an encrypted signal. The system further comprises a communication interface configured to transmit the encrypted signal to a host controller for processing the encrypted signal.

Similarly to the above system for thermal counting, the system comprises a passive thermal sensor, and a reader configured to measure an electrical property of the thermal sensor, and to generate a signal based on the measured electrical property. In this case, however, the passive thermal sensor is configured to detect the occurrence of thermal exposure events and to record the occurrence of the thermal exposure event via alteration of an electrical property of the thermal sensor. The system also further comprises a local controller configured to process the signal to generate an encrypted signal.

In other words, a system for general detection of thermal events (including, but not limited to, thermal cycle counting) is provided. This includes a passive thermal sensor that detects and records thermal exposure events by altering an electrical property of the sensor in a non-transient manner. The system may also include a reader that measures the altered electrical property of the thermal sensor and generates a corresponding signal. Additionally, the system may comprise a local controller that processes the signal to create an encrypted version, and a communication interface that sends the encrypted signal to a host controller for further processing.

This system provides a secure and reliable method for detecting and recording thermal exposure events. The use of a passive thermal sensor with non-transient alterations of electrical properties may allow for long-term storage of thermal event data without the need for constant power or active monitoring. This feature may be particularly useful in applications where continuous power supply is not feasible or where historical temperature data needs to be preserved over extended periods.

Additionally, the incorporation of a local controller that processes the signal to generate an encrypted signal, coupled with a communication interface for transmitting this encrypted data to a host controller, may enhance the security and integrity of the thermal exposure information. This encryption process may help protect sensitive temperature data from unauthorized access or tampering during transmission, which may be crucial in industries where temperature monitoring is critical for safety, quality control, and/or regulatory compliance.

To be clear, the system for thermal cycle counting detects and records a cumulative count of thermal cycles. This means that the system may provide a measurement of the number of times the temperature has been raised to a predetermined high temperature range (or specific temperature) for a predetermined amount of time, before being lowered to a predetermined low temperature range (or specific temperature) for a predetermined amount of time. In contrast, the system for monitoring thermal exposure events detects and records datils of thermal exposure events. This may include detection and recording a cumulative count of thermal cycles. Nevertheless, thermal exposure events are not limited hereto. Thermal exposure events may also encompass thermal bursts (fast temperature increases), thermal ramps (gradual temperature increases/decreases), thermal step responses, thermal fluctuations or anomalies, and so on. The system may thus record the occurrence of these events, and/or the specifics of these events such as peak temperature, average temperature, timing, etc. In some cases, the system may record a temperature profile over time.

It should be appreciated following aspects may be applied to, or employed in, either of the system for thermal counting and the system for monitoring thermal exposure events.

### Encryption

The system of the first aspect may further comprise a local controller configured to process the signal from the reader to generate an encrypted signal. In this case, the communication interface is configured to transmit the encrypted signal to the host controller. As set out above, this is present in the system of the second aspect.

The local controller may be any device provided in proximity to the reader and communication interface, that is capable of apply an encryption algorithm (whether via software, hardware, or firmware) to the signal to generate a signal in encrypted form.

Encryption of the signal may ensure protect the integrity and functional safety of the system. In some cases, it may be possible to intercept the signal being transmitted between the communication interface and the host controller. Accordingly, encrypting the signal may ensure that the measurement information is not compromised. This may be particularly important when privacy of the signal is key, for example when the information in the signal comprises proprietary information. Generally, the encryption ensures that only the intended recipient (in this case, the host processor) can view the content of the signal.

### Physical Unclonable Function (PUF)

More specifically, the local controller may comprise a physical unclonable function (PUF) unit configured to generate a unique encryption value based on a physical property of the PUF unit, and to modify the signal based on the unique encryption value to generate the encrypted signal. For example, the unique value generated by the PUF may be used directly as a cryptographic private key, or to regenerate a cryptographic private key that has been stored using a method that requires the PUF output to complete regeneration (e.g., a fuzzy extractor).

The PUF may be a hardware-based security primitive that leverages inherent physical variations to generate unique and unpredictable responses. PUFs may exploit manufacturing process variations, resulting in subtle differences between nominally identical devices. These differences may be generally imperceptible but can be measured and used to create a unique characteristic. The resultant challenge-response behaviour of the PUF may be consistent for a given PUF but may vary between different PUFs, despite being designed to be the same.

In this case, the PUF is used to generate a unique encryption value (e.g., a cryptographic key). The unpredictable nature of the PUFs may make them suitable for creating high-entropy encryption values that can be regenerated on-demand. This eliminates the need for additional memory devices. That is, the PUF is robust against harsh conditions potentially experienced by the system as it regenerates the unique encryption value on demand, and therefore may be particularly suitable for the purpose of encryption of signals in a system for thermal cycle counting.

In some implementations, PUFs may use various circuit elements, such as SRAM cells, ring oscillators, or arbiter circuits. When stimulated with a challenge input, a PUF may produce a response output that is dependent on the specific physical characteristics of the device. This challenge-response behaviour may be consistent for a given device but may vary between different devices, even those manufactured on the same wafer.

The PUF may be a reconfigurable PUF. By way of specific example, the PUF unit may be a diffusion-based reconfigurable PUF. The PUF unit in this case comprises a diffusion element (i.e. a composition or compound capable of diffusing into a silicon wafer) provided on or adjacent a substrate and arranged such that a composition or a compound can diffuse from the diffusion element into the silicon wafer. The diffusion value of the substrate can be read out as the current PUF output. For example, the substrate may be a silicon wafer. To reconfigure the PUF state, the conditions which lead to the diffusion can be activated so as to alter the diffusion state to sufficiently alter sensor read-out value. One method of alternating the diffusion state is to apply heat to the diffusion element and silicon wafer. The PUF unit may accordingly comprise a heating element circuit placed next to the diffusion element and substrate (e.g. silicon wafer) configured to heat the diffusion element and substrate.

Since the diffusion state can be altered by heat, leading to a change in the response of the PUF, the PUF can be utilized as a further protection against excessive temperatures. In particular, exposure of the PUF to a particular temperature, for example above a set temperature threshold, leads to failure of authentication. This, in turn, can be used to prevent a user from operating the system to which the PUF is applied. Together with the passive thermal sensor, this can provide further protection against excessive heat exposure. It is also effectively impossible to reverse the process and revert to the original key, such that this is an effective guard against attempts to hide excessive heat exposure. In other or additional embodiments, other events which alter the diffusion state may be monitored using a PUF.

The PUF unit may also be utilized as an anti-counterfeiting measure for the system. Indeed, the unique characteristics of each PUF enables verification of the authenticity of the system, and to detect potential tampering or cloning attempts. The unique encryption value may be embedded in the silicon wafer such that a diffusion reaction corrupts the unique encryption value. In this way, the unique encryption value stored in the silicon wafer may be destroyed directly by exposure to environmental conditions outside of the intended operation range of the system.

In further embodiments, the PUF unit may be configured such that, upon tampering of the system, the PUF unit is exposed to a particular temperature, for example above a set temperature threshold. This can alter the diffusion state of the PUF. For example, this may be achieved by an exothermic reaction that occurs upon tampering (e.g., breaking of a casing) of the system. By exposure to a high temperature, the diffusion state of the PUF may be altered, such that the unique encryption value is irrecoverably lost. That is, the act of tampering would therefore prevent the PUF from recovering the unique encryption value, such that that no meaningful data may be output by the system. This loss would be also detectable, and therefore a user may be able to determine when tampering has occurred. In such embodiments, the system may further comprise a housing or enclosure comprising at least one component of the system (which may be the passive thermal sensor and/or the component to which the passive thermal sensor is mounted) and further comprises a tamper unit configured to heat the PUF on tampering of the housing or enclosure so as to alter the diffusion state of the PUF.

Another example may be the use of the PUF to protect against invasive attacks on a circuit, such as a Focused Ion Beam (FIB) edits, which would remove and/or perturb the substrate and, therefore, alter the readout from the PUF.

It will be appreciated that a PUF may be subject to some diffusion of the diffusion element into the substrate at a lower rate under ambient conditions or due to Brownian motion (conditions below a threshold, such as a temperature threshold). This could lead to a detectable change over time. Accordingly, the system may comprise a controller or processor (e.g. at least one of the local controller or the host controller) configured to account for diffusion under an environmental threshold, such as a temperature threshold. This may be based on predicted diffusion patterns, for example obtained by exposure of PUFs to such conditions and generating a corrective algorithm based on the observed exposure.

For example, a fuzzy extractor may be provided that is configured to enable the reliable regeneration of a fixed value from a noisy source through a configurable error correction threshold. Benign events, such as standard part aging, may result in a small amount of diffusion. Setting the error correction threshold to the upper bound of this expected change from benign events enables the PUF to continue to reliably regenerate the value. However, diffusion due to temperature exposure beyond the expected operating conditions are likely to result in significantly more changes in the PUF output. When these changes exceed the error correcting code threshold of the fuzzy extractor, the PUF output is no longer able to regenerate the value. Setting the error correction code's capacity high enough to cover some diffusion allows the part to continue to operate under normal conditions, whereas diffusion due to exposure to temperature ranges beyond the part's operating bounds will exceed the error correction code's capacity and prevent the PUF from regenerating the value.

In one embodiment, a fuzzy extractor may perform an exclusive-or (XOR) operation over the PUF output, O, and the error corrected value to be recovered, ECC(Value). This value, H=O XOR ECC(Value) may be referred to as helper data. The helper data reveals nothing about the underlying value, as it is simply the result of an XOR operation with the PUF output. To recover the error corrected value, the PUF is queried and outputs a new output, O′. If the number of bit differences between the original output, O, and the new output, O′, is fewer than the error correcting code ECC's capacity, then the error decoding algorithm is able to regenerate the error corrected value from Decode(O XOR O′ XOR ECC(Value)). However, if the number of bit differences between the original output, O, and the new output, O′, exceeds the error correction code's capacity, the decoding algorithm will fail and will be unable to recover the error corrected value. The capacity of the error correction code can be configured such that it serves as a threshold separating the maximum expected bit differences due to benign events (e.g., ambient heating), from the minimum expected bit differences due to exposure to environmental conditions beyond the expected operating range.

Additionally, the PUF may be intentionally subjected to heating to reconfigure its behaviour. The reconfiguration process may be determined by an algorithm, such that the PUF may be prevented PUF from generating previous values in support of anti-tamper, anti-rollback, or monotonically non-decreasing counter functionality. In other words, the PUF may therefore be intentionally subjected to heating in response to tampering events, such that it is incapable of generating the fixed value. This may prevent further use of the system for thermal monitoring when the system has been tampered with, thereby improving security of the system.

### Processing Unit

The systems disclosed herein may further comprise a processing unit configured to process the signals generated by the passive thermal sensor of each system to provide thermal data. In some embodiments (including but not limited to the first aspect), the system may further comprise a processing unit configured to process the signal to determine the cumulative count of the thermal cycles. This may further determine other thermal cycle data. Embodiments (including but not limited to the second aspect) may further comprise a processing unit configured to process the signal to determine the occurrence of the thermal exposure event. This may further determine other thermal exposure event data.

A part of the system may also comprise a device for processing the signal and thus deducing thermal data from the signal (including the cumulative count of thermal cycles detected by the thermal sensor, or the detected thermal exposure events). The thermal data (i.e. thermal cycle data and/or thermal exposure event data) may then be used for subsequent analysis or stored for future referral and analysis.

In cases where the thermal sensor is placed in proximity to a component to be monitored, the processing unit may be configured to analyse the thermal data (i.e. thermal cycle data and/or thermal exposure event data) to generate component data describing a condition of the component.

The component data may describe various aspects of the component to which the thermal sensor is near, that change as a result of exposure to elevated temperatures. That is, exposure to certain temperatures may cause components to degrade due to associated stresses, particularly if those components have been exposed repeatedly to elevated temperatures for elongated periods of time. The component data may therefore reflect this degradation. For example, the component data may provide an expected remaining lifetime value of the component, and/or a degradation value of the component or a part thereof.

Accordingly, where thermal cycle data is recorded, the processing unit can leverage the thermal cycle data including the cumulative count of the thermal cycles to predict the condition of the component near which the thermal sensor is placed. In this case the thermal cycle data will include information regarding the number of thermal cycles experienced by the component at least. It is well known that thermal cycling can lead to degradation of components, and therefore this information can be utilised to predict a condition of the component. This may enable early detection of anomalies, prediction of remaining component lifetime, and accurate tracking of thermal stress over time. Thus, preventative action may be taken, potentially leading to increased reliability and longevity of components subject to thermal cycling. Similarly, where the thermal exposure event is recorded, the processing unit can leverage the thermal exposure data to predict the condition of the component near which the thermal sensor is placed.

In some cases, the processing unit may compare the component data to an expected profile of the component. The expected profile may describe thermal conditions the component is expected to be exposed to, and the resultant expected component data as a result of such exposure. When a difference between the determined component data and expected component data diverges, then this difference may be flagged, and an alert may be generated. Indeed, such a difference may indicate anomalies in the exposure conditions of the component, unexpected degradation of the component and/or faults of the component. The thermal data and component data (as well as the potential flags and alerts) may be output by the processing unit. The processing unit may output this data to be stored for future analysis or reference. Alternatively, the processing unit may immediately output this data to a user. For example the processing unit may provide this data to a display to present the data to the user. Alternatively, a sensory output may be provided to alert the user to identified faults of the component and/or deviations in the thermal conditions experienced by the component.

### Machine Learning

The processing unit may be configured to analyse the thermal data using a machine learning algorithm trained to receive thermal data and output component data based on the received thermal data. According to an embodiment where thermal cycle data is obtained, the processing unit may be configured to analyse the thermal cycle data using a machine learning algorithm trained to receive thermal cycle data and output component data based on the received thermal cycle data. According to an embodiment where thermal exposure event data is obtained, the processing unit may be configured to analyse the thermal exposure event data using a machine learning algorithm trained to receive thermal exposure event data and output component data based on the received thermal exposure event data.

That is, the processing unit provides thermal data (e.g., including the cumulative count of the thermal cycles, thermal exposure event data, thermal event data, etc) to a machine learning algorithm. The machine learning algorithm is trained to predict, for the thermal data, component data describing a condition of the component.

Methods of training a machine-learning algorithm are well known. Typically, such methods comprise obtaining a training dataset, comprising training input data entries and corresponding training output data entries. An initialized machine-learning algorithm is applied to each input data entry to generate predicted output data entries. An error between the predicted output data entries and corresponding training output data entries is used to modify the machine-learning algorithm. This process can be repeated until the error converges, and the predicted output data entries are sufficiently similar (e.g. ±1%) to the training output data entries. This is commonly known as a supervised learning technique.

Accordingly, the machine learning algorithm may be trained using a set of thermal data and associated component data. This training data may be specific to the type of component such that the machine learning algorithm is tuned to produce component data based on thermal cycle data for the specific component. Alternatively, the machine learning algorithm may be trained using training data for a variety of different components, such that the machine learning algorithm is capable of producing component data based on thermal cycle data for a variety of components.

The use of a machine-learning algorithm trained to analyse thermal data and output component data may provide several advantages. This approach may enable more accurate and efficient analysis of complex thermal patterns, potentially identifying subtle correlations or trends that traditional analytical methods might overlook. The machine-learning algorithm may adapt and improve its performance over time as it processes more data, potentially leading to increasingly precise predictions and insights about component behaviour under various thermal conditions. Additionally, this method may allow for faster processing of large volumes of thermal data, potentially reducing the time and resources required for analysis in industrial or research settings.

### Digital Twin Model

Additionally, or alternatively, the processing unit may be configured to analyse the thermal data based on a digital twin model configured to emulate behaviour of the component. This can be thermal cycle data and/or thermal exposure event data.

By utilizing a digital twin model to emulate the behaviour of the component, the processing unit may be able to perform more accurate and comprehensive analyses of the thermal data. The digital twin model may allow for virtual simulations of various operating conditions and scenarios, potentially providing insights into the component's performance, wear patterns, and potential failure modes that may not be easily observable through traditional analysis methods. Additionally, this method may enable predictive maintenance strategies, as the digital twin model may help forecast future component behaviour based on current thermal data. This may result in reduced downtime and extend the component's operational lifespan.

### Fault Identification

Furthermore, the processing unit may be further configured to process the component data to identify one or more faults of the component.

Fault identification based on the component data may be an important aspect facilitated by the proposed monitoring system. For example, if the component has been exposed to an excessive number of thermal cycles, it may be determined that a fault is likely. Therefore, proactive steps can be taken to ensure safety and reduce potential down time.

Where a fault is detected, the processing unit may be configured to generate an alert or alarm. The alert or alarm may result in operation of a local physical output, such as an alarm, or this may generate a remote alert or alarm, for example via a communications network. Accordingly, where the processing unit is a part of the local controller, the processing unit may be configured to generate a local alert or alarm via an alert unit provided locally (e.g. locally to the passive thermal sensor, which can be on the passive thermal sensor) and/or the processing unit and the communication interface may be configured to transmit the alert to the host controller.

### System Architecture—Processing Unit, Controller (Host and/or Local) and Communication Interface

In some embodiments, the processing unit may be provided as part of the host controller. In other embodiments, the processing unit may be provided as part of the local controller. In some cases, the functionality of the processing unit may be duplicated and provided on both the host controller and the local controller.

That is, the processing of the signal to provide the thermal data, and potentially the component data and identification of faults, may be performed locally to the reader and communication interface, or may be performed on another device. Or both, as a combination or an additional redundancy. By performing this locally, a fully integrated system may be provided. On the other hand, extensive computational resources may be available to the host processor in the form of cloud computing or other processing centres which may facilitate more complex analysis of the signal.

In addition, the system may further comprise a memory unit configured to store the determined thermal data. Where thermal cycle data is present, the system may further comprise a memory unit configured to store the determined thermal cycle data. Where thermal event exposure data is present, the system may further comprise a memory unit configured to store the determined thermal exposure event data.

The memory unit may provide storage of the thermal data that may ensure that the data is readily available when required, rather than when the system produces such data.

The communication interface may be further configured to receive an instruction from the host controller to initiate reading of the electrical property by the reader.

This may provide enhanced flexibility and control over the interrogation of the thermal sensor when required, as measurements can be taken at specific intervals or in response to certain conditions detected by the host controller. In other words, by allowing the host controller to initiate the reading of the electrical property, the system may be able to coordinate the timing of measurements with other operations or events. Additionally, this approach may enable on-demand readings, potentially reducing power consumption by only activating the reader when necessary, as well as facilitating more efficient data collection and analysis.

In some embodiments, the system may comprise a local controller configured, responsive to the communication interface receiving the instruction, to control the reader to generate the signal.

The local controller can therefore process the instruction from the local controller (received via the communication interface) and determine proper operational control of the reader.

Further, the communication interface may comprise a wired connection to the host controller via which the communication interface is configured to transmit the signal.

In other words, the communication interface and host controller may communicate via a physical connection/transceiver. The wired connection may comprise one or more wires connecting the communication interface and the host controller. The signal may be transmitted via said wires, and the above-mentioned instruction may be transmitted by said wires. The wired connection may ensure a fast and secure means for transferring data, facilitating real time monitoring and control.

Additionally, or alternatively, the communication interface may comprise a wireless transmitter via which the communication interface is configured to transmit the signal to the host controller.

Put another way, the communication interface and host controller may communicate via a non-physical connection. For example, this may be via a radio, RFID, NFC, Bluetooth, or Wi-Fi connection. Additionally, the transfer of data may be bi-directional, in that the wireless transmitted may also receive data from the host controller (e.g., the instruction as described above). The wireless connection may facilitate easy installation of the monitoring system on an apparatus to be monitored.

### Power

In some embodiments, the system further comprises a power harvesting module configured to obtain power for the reader, and/or communication interface. The power harvesting module may also provide power to the local controller, if provided.

This may enable the system to operate autonomously without requiring an external power source or the need for large batteries or power cables. This may be particularly beneficial in remote or hard-to-access locations (e.g., within complex machinery) where regular maintenance is challenging. The power harvesting module may extend the operational lifespan of the system by continuously replenishing the power supply. It may also allow for a more compact and lightweight design of the system. Furthermore, the power harvesting module may contribute to improved energy efficiency and sustainability of the system by utilizing ambient energy sources that might otherwise go unused.

In some aspects, the power harvesting module may be configured to generate the power using ambient thermal energy.

That is, the power harvesting module may incorporate thermal energy harvesting capabilities. This approach may utilize thermoelectric generators (TEGs) to convert temperature differences into electrical energy. Thermoelectric generators (“TEGs”), (also referred to as Seebeck generators or thermoelectric devices/generators) convert heat (e.g., thermal energy) into electric energy (e.g. a voltage output) through a phenomenon known as the “Seebeck effect”. A temperature gradient is formed by contacting one side of the TEG with a hotter or colder surface. This temperature gradient results in the diffusion of charge carriers in a semiconductor material in the device. The flow of charge carriers between the hot and cold sides or regions in turn creates a voltage difference. The TEGs may be composed of materials with high thermoelectric properties, such as bismuth telluride or lead telluride. The use of ambient thermal energy (i.e., heat in the surrounding environment) may be particularly beneficial for the present system due to the likely exposure of the system to elevated temperatures in thermal cycle counting.

In other aspects, the power harvesting module may be configured to receive power from the host controller.

The power harvesting module may thus utilize electromagnetic induction (via coils, for example) or radio frequency energy harvesting (via specialised antennas, for example) to extract energy wirelessly from the host controller. This may provide a reliable, predictable, and wireless form of power for the system.

In some embodiments, the system may further comprise an energy storage device configured to store the obtained power for the reader and/or the communication interface.

The energy storage device (e.g., a battery, capacitor, etc.) may ensure that the system can operate to read the electrical property of the sensor reliably even when energy harvesting, or an external source of power is not available. This therefore improves reliability and flexibility of the system.

Furthermore, the system may further comprise a power management unit configured to control power provided to the reader and/or the communication interface.

The power management unit controls the flow of power/energy between a power source (which may be an energy storage device, or an energy harvesting unit as described above) to components of the system such as the reader, communication interface or the local controller.

By controlling power provided to the reader and/or communication interface, the system may optimize energy consumption, enabling the energy from the energy harvesting system and/or energy storage device to tickle appropriate amounts of power to the system. This power management capability may allow for dynamic adjustment of power allocation based on operational needs, potentially improving overall system efficiency. In some cases, the power management unit may enable low-power modes or selective activation of components, which may be particularly beneficial when the system is applied to situations where energy conservation is a priority.

### Casing/Housing

In certain embodiments, the system may further comprise a casing configured to house the thermal sensor, reader, and/or communication interface. The casing may, in some embodiments, fully enclose the thermal sensor, reader and/or communication interface.

The casing/housing may therefore provide the thermal sensor, reader and communication interface (and further optionally the local controller, power harvesting unit, etc.) as one complete package. Each of these components may be provided on a PCB. These components may be completely or partially enclosed by the casing.

The casing may be hermetically sealed.

If hermetically sealed (i.e., completely airtight), then deterioration of the components included in the casing may be slowed by prevention of the ingress of gases and/or liquids. Indeed, this provides protection from environmental factors such as moisture, dust and contaminants. This may be particularly advantageous when the system is used in applications where chemicals and/or radiation are present which may increase the rate of deterioration. In some cases, this may mean that the system has a longer life span and may be deployed for longer periods of time without replacement.

The system may also comprise a thermal conduit configured to transfer heat from outside the casing to the thermal sensor.

The thermal conduit may be a thermally conductive element that is used to effectively transfer heat, particularly from the outside of the casing to inside the casing. This may therefore ensure that the casing does not obstruct the ability of the thermal sensor to monitoring the thermal cycles or a thermal exposure events, by ensuring that the heat condition outside of the casing is properly conveyed to the thermal sensor.

### Thermal Sensor(s)

In some embodiments, the thermal sensor may be a diffusion-based sensor. Accordingly, alteration of the electrical property may be associated with localized diffusion of a diffusant within the diffusion-based sensor in response to exposure of the diffusion-based sensor to a predetermined temperature for a predetermined length of time. The diffusant may diffuse from a reservoir to a diffusion region in communication with the reservoir. The reservoir may be formed at a surface of a substrate, wherein the reservoir serves as a first electrode, and wherein the sensor further comprises a second electrode formed at the surface and formed of a material different from the reservoir.

That is, system may comprise a thermal sensor that operates based on diffusion principles. In such cases, the change in the electrical characteristic may be related to the localized movement of a diffusing substance within the diffusion-based sensing element. This movement may occur when the diffusion-based sensing element is subjected to a specific temperature for a particular duration of time.

The localized diffusion of a diffusant within the sensor in response to specific temperature and time conditions may provide a more precise and reliable measurement of thermal exposure. This may enable for the detection of cumulative thermal effects over time, which may be particularly useful in applications where monitoring both temperature and duration of exposure is important. Additionally, the diffusion-based mechanism may potentially offer improved sensitivity to small temperature changes and may be less susceptible to interference from external factors compared to some other types of thermal sensors. Furthermore, the diffusion-based sensor may not require power (i.e., may be passive), and may record the occurrence of thermal cycles or a thermal exposure event in a non-transient manner.

Examples of thermal sensors suitable for application in the proposed systems include the passive thermal diffusion devices and passive time-temperature integral (TTI) sensors found in US2017/299650A1, U.S. Pat. No. 11,988,708 B2 and U.S. Pat. No. 11,269,006 B2, which are incorporated herein by reference.

Further examples of suitable thermal sensors include the passive thermal diffusion devices, passive TTI sensors, and passive thermal cycle counters found in US2024/159596A1, which is incorporated herein by reference.

The thermal sensor may comprise a bipolar diffusion transistor, for example as set out in US2017/299650A1, U.S. Pat. No. 11,988,708 B2 and U.S. Pat. No. 11,269,006 B2. Bipolar diffusion transistors consist of three layers of doped semiconductor material, namely the emitter, base, and collector. The emitter region may be (heavily, i.e. greater than the collector region and the base region) doped with either n-type or p-type impurities, while the base region may be (lightly) doped with the opposite type of impurity. The collector region may be (moderately—i.e. to a lesser extent (less than) than the emitter region but a greater extent than the base region) doped with the same type of impurity as the emitter. The operation of a bipolar diffusion transistor typically relies on the movement of both electrons and holes between the emitter and base. When a voltage is applied across the emitter-base junction, it causes carriers to diffuse from the emitter into the base region. There may be further layers, such as a substrate on which the emitter, base and collector regions are formed. There may be interlayer between the emitter, base and collector regions and the substrate (e.g. an epitaxial layer). In the present case, exposure to certain thermal conditions may cause certain dopants to be diffused into the collector region. Accordingly, this may cause the amplification of the voltage by the bipolar diffusion transistor to change. This may therefore be leveraged to detect and record the occurrence of a thermal cycle, or a thermal exposure event.

The thermal sensor may comprise a field-effect transistor (FET) diffusion transistor. These semiconductor devices that utilize the principle of diffusion to control the flow of electric current in a channel region of a semiconductor material between a source and drain. As with a general FET structure, the FET diffusion transistor includes a gate electrode positioned above the channel region (which may be separated from the channel region by a thin insulating layer). When a voltage is applied to the gate, it may create an electric field that influences the distribution of charge carriers in the channel, thereby modulating the current flow between the source and drain. In some cases, the diffusion process may involve the movement of charge carriers (electrons or holes), e.g. from regions of high concentration to regions of low concentration within the semiconductor material. This diffusion of carriers may contribute to the current flow in the device.

The diffusion of carriers significantly influences the transistor's characteristics, such as its switching speed and threshold voltage. Accordingly, in the present case, exposure to certain thermal conditions may cause certain dopants to be diffused into the channel region. Accordingly, this may alter characteristics of the FET. This may therefore be leveraged to detect and record the occurrence of a thermal cycle, or a thermal exposure event.

The thermal sensor may comprise a dual gate FET structure. For example, a switch device comprising a substrate; a p-n junction comprising a first p-doped layer provided on the substrate and a first n-doped layer provided on the substrate and opposing the first p-doped layer; a conduction layer provided on the substrate (between the first n-doped layer and the substrate and between the first p-doped layer and the substrate) and extending from a first region adjacent the p-doped layer to a second region adjacent the n-doped layer, wherein the conduction layer comprises a plurality charge carriers moveable within the conduction layer and wherein, in an initial state, the concentration of charge carriers in the first region is higher than in the second region; and wherein the first p-doped layer is vertically offset relative to the first n-doped layer to provide an offset region adjacent the first p-doped layer in which a plane parallel to the surface of the substrate extends through the offset region and the first n-doped layer; and wherein a part of the conduction layer defining at least a part of the first region is provided in the offset region such that an electric field generated by the p-n junction opposes the migration of the charge carriers from the first region to the second region. This switch device accordingly provides a structure which acts as a dual-gate field effect transistor (FET, or MOSFET). In this way, there is a first FET or gate structure comprising the first p-doped layer which forms a first metal oxide semiconductor (MOS) FET with the substrate and a second FET or gate structure comprising the first n-doped layer which forms a second MOSFET with to the substrate. The conduction layer can be provided between the first p-doped layer and the substrate and, similarly, between the first n-doped layer and the substrate and extends therebetween so that it provides a diffusion pathway between these structures for the charge carriers. The first gate structure has the higher concentration region (i.e. the first region) adjacent it (which can be between the first p-doped layer and the substrate) and the second gate structure has the lower concentration region (i.e. the second region) adjacent it (which can be between the first n-doped layer and the substrate). In this state, because the first n-doped layer and first p-doped layer are electrically separated and the first region is separate from the first n-doped layer, the second gate has a first state (which can be considered to be “off”). The two regions within the conduction layer—the first region comprising a higher concentration of charge carriers (in an initial state) and a second region having a lower concentration (in the initial state) mean that the charge carriers will seek to move through the conduction layer from the higher concentration region to the lower concentration region; however, the charge carriers in the first region and are held in the first region by an electric field acting in opposition which prevents them from moving to the second region—i.e. as an electrostatic barrier. When a threshold voltage is applied to the switching device, it switches off the electric field within the switching device and allows the charge carriers to move from the first region to the second region. Specifically, the application of the voltage charges the gate of one MOSFET (e.g. the first gate) to the threshold voltage, which reduces or turns off the electric field. With the electric field off or reduced, charge carriers can flow across the conduction layer to the second region. The second MOS, which is initially in the first state (e.g. off) because of the second region located between the first n-doped layer and the substrate now has charge carriers between these layers and forms another, detectable state (e.g. “on”). This turning of the second MOS enables a user to determine the state of the switch device, for example because the threshold voltage of the device itself has changed. The device can therefore be interrogated (e.g. through the application of a voltage) to the second gate (i.e. the comprising first n-doped layer) to determine whether the charge carriers are in the second region or not.

By designing the geometry of the switch device such that the opposition to the flow of charge from the first region to the second region down a concentration gradient is achieved without power, this may enable the switch device to able to retain the data stored within it when power is not present. Specifically, the device of the present disclosure provides a p-n junction which generates an electric field which opposes the migration of charge carriers from the first region to the second region. This accordingly directly opposed the move, as opposed to simply interfering with movement (e.g. where an electric field is perpendicular to the direction that charge carrier must move in order to migrate from a first region to a second region), which may not retain these in the first region sufficiently. It follows that sensors incorporating such switching devices can more robustly record and store data.

In some embodiments where an occurrence of a thermal cycle is detected, the system may further comprise a plurality of passive thermal sensors, each configured to detect an occurrence of thermal cycle; and record a cumulative count of thermal cycles via alteration of an electrical property of the respective thermal sensor. Each alteration of the electrical property is non-transient. In this case, the reader may be configured to measure the electrical property of each thermal sensor, and to generate the signal based on the measured electrical property of each thermal sensor. In some embodiments where an occurrence of a thermal exposure event is detected, the system may further comprise a plurality of passive thermal sensors, each configured to detect an occurrence of the thermal exposure event; and record the occurrence of the thermal exposure event via alteration of an electrical property of the respective thermal sensor. Each alteration of the electrical property is non-transient. In this case, the reader may be configured to measure the electrical property of each thermal sensor, and to generate the signal based on the measured electrical property of each thermal sensor.

In other words, the system may include a plurality of thermal sensors, each individually configured to detect the occurrence of, and record, thermal events (i.e. thermal cycles or thermal exposure events). Whilst the increase in number of thermal sensors increases complexity, cost and size of the systems, in some aspects this may increase redundancy and therefore improve robustness and ultimately reliability and accuracy of the system. In another aspect, each thermal sensor may be configured to measure different thermal events, such as different thermal cycles (i.e., thermal cycles having different peak high temperatures and peak low temperatures) or different thermal exposure events (having different temperature thresholds and/or exposure lengths, for example), increasing the ability of the system to monitor thermal exposure. Furthermore, the thermal sensors may be placed in different locations to determine thermal events in the different locations, and therefore potentially provide the ability to appreciate a spatial profile of thermal exposure.

### Uses

The proposed thermal cycle counting systems and thermal event monitoring systems may be utilized in various applications and environments. Specifically, the proposed systems may find uses, for example, for monitoring in autoclaving, automotive industries, aeronautical industries, pharmaceutical industries, fluid production industries, robotics, and power generation industries. Of course, these applications are non-exhaustive.

As briefly mentioned above, the proposed system may be particularly well suited for autoclaving cycle monitoring. Autoclaving involves raising the temperature of medical equipment to a predetermined temperature range for a predetermined amount of time at certain pressures and humidity levels. For example, the temperature may be raised to at least 120 °C, for example 132 °C-137 °C, for at least 30 seconds, such as at least three minutes. Accordingly, the thermal sensor may be configured to detect an occurrence of a thermal cycle where the temperature of the thermal sensor is raised to a temperature of at least 120 °C (e.g. at least 121 °C) for at least 30 seconds, such as at least 132 °C for at least 30 seconds. Of course, this is meant by way of example only, with other autoclaving systems potentially raising the temperature to a different range for a different length of time.

It is important to track the number of autoclave cycles experienced by medical equipment, as it induces thermal stress and corrosion of medical equipment, limiting the number of safe reuses. In addition, it is important to ensure that the autoclave process has exposed the medical equipment to the correct temperatures for the correct time to ensure adequate sterilization. Accordingly, it is important to track the number of autoclave cycles, as well as the proper execution of the autoclave cycle.

The harsh conditions induced by the autoclave cycle could have a negative impact on typical semiconductor sensing electronics (e.g., thermocouples) and batteries. However, with the proposed passive and non-transient thermal sensor, the need for such electronics and batteries during the autoclave process may be obviated. The proposed system may therefore be particularly suited to monitoring autoclave cycle counting for such medical equipment, both to ensure that the equipment is properly sanitized, and to count the number of times the equipment has undergone autoclaving.

Furthermore, the system must be able to differentiate between an autoclave cycle, and heating due to other sources. For instance, it may be the case that the medical equipment is washed/cleaned at relatively high temperatures (e.g., in hot water, at temperatures of up to 95 °C) before autoclaving, and then dried after autoclaving at high temperatures (e.g., in hot air up to 121 °C). Accordingly, the system must therefore be able to distinguish between different high temperatures to provide an accurate count of the number of autoclave cycles.

Typically, medical equipment (particularly surgical equipment) can only be reused a certain number of times before it should be replaced, which is usually specified by the manufacturer. However, it is often the case that the usage number for medical equipment is not tracked and based on an estimate of the number of autoclave cycles. It is therefore of interest to obtain an accurate count of the number of autoclave cycles experienced by the equipment to have a better understanding of the number of uses of the medical equipment.

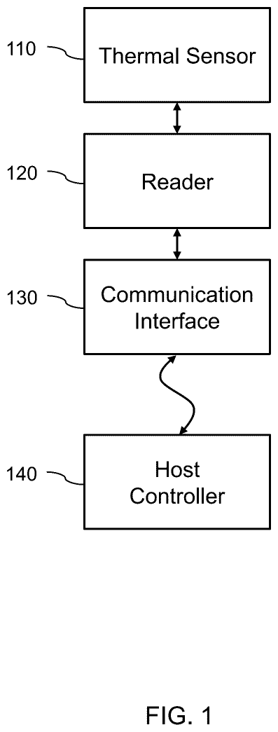

In particular embodiments, the passive thermal sensor may be a thermal cycle detector as disclosed in US2024/159596, such as that of FIG. 1. Alternatively or additionally, the time at temperature integral (TTI) sensor disclosed in U.S. Pat. No. 11,988,708 B2 and U.S. Pat. No. 11,269,006 B2 (e.g. that disclosed in conjunction with FIG. 42B), the contents of which are incorporated by reference in their entireties, may be utilized as the thermal sensor. This may provide an accurate autoclave cycle count when the temperature and time-at-temperature parameters of the autoclaving are known.

The proposed systems may also be particularly useful in automative applications, with specific areas that experience high temperatures (e.g., >200 °C). For example, parts of the gas exhaust systems, engines, transmission, or braking systems may reach very high temperatures. For electric or hybrid vehicles, parts of the battery may also reach high temperatures. Furthermore, aeronautical parts may also experience extreme temperature conditions. Elevated temperature for elongated periods of time may lead to deterioration and failure of these parts. Accordingly, the proposed system may be used to monitor and record thermal conditions of these parts to alert users to anomalous conditions and/or potential failures. Accordingly, the thermal sensor may be configured to detect a thermal exposure event where the temperature of the thermal sensor is raised to a temperature of at least 150 °C, such as at least 200 °C.

In specific embodiments, the communication interface may be wireless, such that the need for long cables with potential for errors fed back to a central control unit may be avoided. In other embodiments, exposed contacts connecting to the system may be provided to enable the signal to be accessed.

Furthermore, the proposed systems may be employed to monitor thermal conditions in vats of high value fluid. In this case, the thermal sensor may be provided at specific places within the vat, or may be allowed to move freely within the fluid. More specifically, some chemical and pharmaceutical processes involve solutions in vats that mature over time. The maturing process can involve various temperature events, and the temperature of the fluid may indicate the stage of processing of the fluid. Accordingly, it may be beneficial to monitor such fluid using the proposed system.

In some aspects, such systems may be employed in industrial settings to monitor equipment and machinery to monitor potential deterioration or exposure to unsafe temperatures. The system may be implemented in manufacturing facilities, power plants, or chemical processing plants to detect abnormal temperature fluctuations and alert operators to unexpected temperature conditions or even potential hazards.

More generally, the systems may be employed to monitor moving parts in general. This may be particularly useful if said moving parts experience harsh environments including elevated temperatures. Unexpectedly high temperatures may mean that movement needs to be ceased before potential safety issues arise. When mechanical parts, such as bearings, begin to fail, this may lead to increase in temperature due to increased friction or other unexpected contact. In other words, mechanical faults in machines can result in significant temperature increase. Further, temperatures in excess of 200 °C can anneal the bearings, resulting in loss of hardness and premature failure

Moreover, the systems may be useful in robotics to monitor the thermal condition of various moving parts of the robot. Robotic failure may arise due to excess temperatures (harming various moving parts) or may result from failures of moving parts. The proposed system may enable this to be tracked even when the robot is damaged, or during power-loss events, which may be critical for safety.

### Specific Implementations

Turning now to FIG. 1, there is depicted a block diagram of a system for monitoring thermal exposure events. More specifically, the depicted system is suitable for thermal cycle counting, or the counting of the number of occurrences of a thermal cycle. As shown, the system comprises a passive thermal sensor 110, a reader 120, and a communication interface 130. In some cases, the system may further comprise a host controller 140 that is communicatively coupled to the communication interface 130.

The thermal sensor 110 is passive, meaning that it does not require an active power source to operate. Primarily, the thermal sensor 110 is configured to detect an occurrence of thermal cycles. That is, the thermal sensor 110 detects a temperature increase from a low temperature peak/range (e.g., room temperature) to a high temperature peak/range, and back to the low temperature range. When such a thermal cycle occurs, the thermal sensor 110 increments a cumulative count of thermal cycles by alteration of an electrical property of the sensor 110 (or an element of the sensor 110). The thermal sensor 110 thus records a cumulative count of thermal cycles via said alteration of the electrical property. The electrical property may be an impedance, a conductivity or any other electrical property that may be altered via change of physical characteristics of a device element. Each alteration of the electrical property is non-transient, meaning that the alteration does not fade with time. However, the alteration may change with further detected thermal cycles.

The thermal sensor 110 may be placed in proximity to a component to be monitored. For example, the thermal sensor 110 may be placed on, in or near a component to be monitored so that thermal exposure events of the component may be detected, recorded, and potentially subsequently processed and analysed. The component may be, for example, a piece of medical equipment so that autoclave cycle counting may be performed. The component may be a component of a vehicle, such as the clutch, so that thermal cycles can be tracked, and proactive maintenance and replacement may occur. The thermal sensor 110 may be placed in a vat of fluid during a manufacturing process, to ensure that the fluid experiences expected temperatures and thus the resultant product is as expected. Of course, these examples of components are non-exhaustive. The thermal sensor 110 may be placed in close proximity to many different components for which it is desirable to appreciate thermal exposure.

In a specific example, the thermal sensor 110 is a diffusion-based sensor 110. Accordingly, the alteration of the electrical property is achieved via localized diffusion of a diffusant within the diffusion-based sensor 110. This diffusion occurs responsive to detection, or as a result of, the thermal cycle. In other words, the diffusion occurs when the diffusion-based sensor 110 is exposed to a predetermined temperature for a predetermined length of time.

To this end, the thermal sensor 110 may comprise a substrate configured to receive diffusion atoms, and a diffusion atom reservoir provided near the substrate. Upon application of thermal energy to the diffusion atom reservoir, diffusion atoms diffuse into the substrate. The presence of diffusion atoms in the substrate therefore indicates the thermal energy applied to the diffusion atom reservoir. The diffusion atom source may comprise aluminium, cobalt, platinum, sulphur, nickel, silver, zinc, gold, chromium, copper, iron, sodium, and potassium atoms, for example.

The reader 120 is configured to measure the electrical property of the thermal sensor 110. In the case that the adjustable electrical property is an impedance of the thermal sensor 110, the reader 120 may determine the impedance of the thermal sensor 110. That is, the reader 120 may apply a fixed voltage to the thermal sensor 110 and measure a current flowing through the thermal sensor 110 which will be proportional to the impedance of the thermal sensor 110. Equally, the reader 120 may provide a fixed current to the thermal sensor 110, and measure a voltage drop across the thermal sensor 110 which will be proportional to the impedance of the thermal sensor 110.

Further, the reader 120 is configured to generate a signal based on the measured electrical property. The signal may be an analog signal having a magnitude describing a value of the adjustable electrical property. Alternatively, the signal may be a digital signal describing a value of the adjustable electrical property.

In some embodiments, the reader 120 may comprise an operational amplifier configured to amplify the measured value of the electrical property of the thermal sensor 110. Furthermore, the reader 120 may comprise an analog-to-digital (ADC) converter configured to convert the measured value of the electrical property to a string of bits.

The communication interface 130 is configured to transmit the signal to a host controller 140. The communication interface 130 may be communicatively coupled to the reader 120 to receive the signal.

In some embodiments, the communication interface 130 comprises a wired connection to the host controller 140 via which the communication interface 130 is configured to transmit the signal. For instance, the communication interface 130 may comprise one or more wires via which the communication interface 130 transfers the signal.

The communication interface 130 may comprise a wireless transmitter via which the communication interface 130 is configured to transmit the signal to the host controller 140. For example, the communication interface 130 may transmit the signal via a radio connection. To this end, the communication interface 130 may comprise an antenna to wirelessly communicate the signal. Alternatively, the communication interface 130 may comprise RFID or NFC interfaces to communicate the signal to the host controller 140.

The communication interface 130 may be configured to transmit the signal via Wi-Fi, Bluetooth, Bluetooth Low Energy, Zigbee, Thread, ANT, ANT+, IEEE 802.15.4, IEEE 802.11.ah, or any other suitable wireless communication protocol. Alternatively, or additionally, the communication interface 130 may be configured to transmit and/or receive data using proprietary connectivity protocols.

The communication interface 130 may comprise an antenna, an RF match, a multiplexer (mix), amplifiers, a receive path, a transmit path, a radio modem, a radio processor, memory access control, a host processor, a digital I/O module, system diagnostics, system power management, mixed signal sensor interface, or any suitable combination thereof. The antenna may be a microstrip antenna, a loop antenna, a slot antenna, a serpentine-shaped antenna, or any other suitable type of antenna. In some embodiments, the antenna may comprise one or more carbon nanotube antennas. The RF match may be connected to the antenna, and may comprise circuitry configured to provide impedance matching, and/or to provide a desired impedance. The multiplexer may be configured to combine and/or separate communication channels in the time domain and/or in the frequency domain. Alternatively, or additionally, multiplexer may be configured to separate transmit signals directed to antenna from receive signals obtained by antenna. The amplifier may be configured to amplify a signal received with antenna. In some embodiments, a receive path may be provided and may be coupled to amplifier. The receive path may comprise a filter in some embodiments. Similarly, the transmit path may comprise a filter, and may be configured to provide a transmit signal to amplifier. Radio modem may comprise circuitry configured to modulate a signal for transmission, and/or demodulate received signals. Radio processor may be configured to select the type of communication protocol, the data rate, the communication channel, the type of data to be transmitted, or any other suitable transmission parameter.

The data to be transmitted may be stored within memory. The radio processor may be configured to access the data stored in memory. The host processor may be configured to control the operations of the communication interface 130. For example, the host processor may control the system power management to place the communication interface 130 in sleep mode. The communication interface 130 may be placed in sleep mode at certain predetermined times. In some embodiments, the communication interface 130 may be placed in a sleep mode, and may wake up at regular intervals, such as once a second, to monitor if a device has provided a wake-up signal.

In some embodiments, the host processor may be configured to perform data compression on the signal to be transmitted. For example, the compression may comprise creating a data set representing the variations in an existing data set. The compression may be performed to decrease the size of the packet to be transmitted. The system diagnostics may be configured to perform tests to verify the integrity of any suitable combination of the components of communication interface 130. In some embodiments, the communication interface 130 may be configured to transmit a continuous flux of data. In such embodiments, the signal may be transmitted in a streaming mode. In other embodiments, the signal may be buffered within a memory. In such embodiments, a processor, such as the radio processor or host processor may be configured to access the data buffered in the memory, and to provide the data to the antenna for transmission.

In some cases, the communication interface 130 may comprise both a wired connection and a wireless transmitter. Accordingly, the signal may be selectively transmitted by the wired or wireless means depending on the application, user preferences, and/or context of the thermal event monitoring. The signal may be sent via both the wired and wireless means simultaneously or sequentially to ensure integrity of the signal and robustness of the communication of the signal.

In some cases, the communication interface 130 may also receive instructions from the host controller 140. That is, there may be bi-directional communication between the communication interface 130 and the host controller 140. Furthermore, the communication interface 130 may transmit further data (other than the signal). In particular, the communication interface 130 may also transmit data regarding various parameters of the communication interface 130, reader 120 and/or the thermal sensor 110. For example, the communication interface 130 may transmit when the reader 120 is able to measure the electrical property, the power status of the reader 120 and/or communication interface 130, or any other relevant metric of the system.

To facilitate communication, the host controller 140 may need to be brought into proximity with the communication interface 130 to receive the signal or may need to be plugged in to receive the signal.

The reader 120 and communication interface 130 may be provided as part of the same structure as the thermal sensor 110. That is, the reader 120 and communication interface 130 may be physically placed in a fixed positioned relative to the thermal sensor 110. In other embodiments, the reader 120 and communication interface 130 may be physically separate from the thermal sensor 110 and may be brought into proximity with the thermal sensor 110 when measurement of the electrical property is desired.

The host controller 140 may receive the signal. The host controller 140 may be configured to process the signal to determine thermal cycle data measured by the thermal sensor 110. The host controller 140 may be further configured to process the thermal cycle data to perform analysis on the thermal cycle data. Furthermore, the host controller 140 may be configured to issue instructions to be received by the communication interface 130. The instructions may include prompts for the reader 120 to measure the electrical property of the thermal sensor 110, for example.

In some cases, the host controller 140 may be a portable handheld device (e.g., a tablet, handheld reader, a smartphone, etc.). In other cases, the host controller 140 may be a static machine.

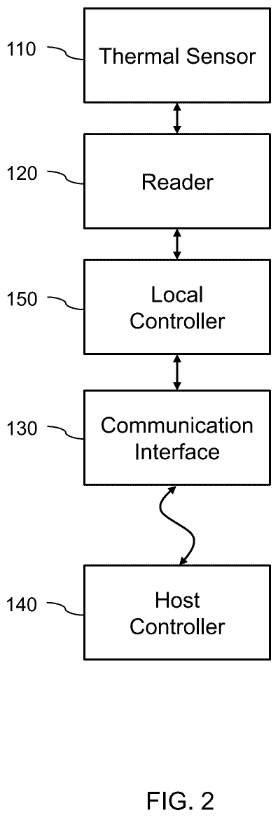

Turning now to FIG. 2, there is depicted a block diagram of another system for monitoring thermal exposure events. As before, the depicted system is suitable for thermal cycle counting, or the counting of the number of occurrences of a thermal cycle. Similarly to FIG. 1, the system comprises a thermal sensor 110, a reader 120, and a communication interface 130. In this case, the system further comprises a local controller 150 that may be communicatively coupled to the reader 120 and the communication interface 130. Repeated description of the thermal sensor 110 and reader 120 is hereby omitted for the sake of brevity.

The local controller 150 may be configured to process the signal from the reader 120 to generate an encrypted signal. In which case, the communication interface 130 may be configured to transmit the encrypted signal to the host controller 140. Encryption may help to protect the integrity and functional safety of the system. In certain examples, the encryption can be accomplished via processing electronics of the local controller 150. The encryption may be accomplished via software firmware, or hardware.

More specifically, various options may be employed for encrypting the signal. In some aspects, symmetric encryption algorithms such as Advanced Encryption Standard (AES), Data Encryption Standard (DES), or Triple DES may be utilized. These algorithms use the same key for both encryption and decryption processes.

In other cases, asymmetric encryption algorithms, also known as public-key cryptography, may be implemented. Examples of asymmetric encryption methods may include RSA (Rivest-Shamir-Adleman), Elliptic Curve Cryptography (ECC), or Diffie-Hellman key exchange. These algorithms use a pair of keys-a public key for encryption and a private key for decryption.

In some implementations, hybrid encryption systems may be employed, combining both symmetric and asymmetric encryption methods. This approach may leverage the speed of symmetric encryption for bulk data and the secure key exchange capabilities of asymmetric encryption.

By way of specific example, the local controller 150 comprises a physical unclonable function (PUF) unit configured to generate a unique encryption value based on a physical property of the PUF unit, and to modify the signal based on the unique encryption value to generate the encrypted signal.

The PUF may be a hardware-based security primitive that leverages inherent physical variations in integrated circuits to generate unique and unpredictable responses. PUFs may exploit manufacturing process variations that occur during chip fabrication, resulting in subtle differences between nominally identical devices. These differences may be imperceptible to the naked eye but can be measured and used to create a unique encryption value.

In some implementations, PUFs may use various circuit elements, such as SRAM cells, ring oscillators, or arbiter circuits. When stimulated with a challenge input, a PUF may produce a response output that is dependent on the specific physical characteristics of the device. This challenge-response behaviour may be consistent for a given device but may vary between different devices, even those manufactured on the same wafer.

By way of specific example, the PUF unit may be a diffusion-based reconfigurable PUF. The PUF unit in this case comprises a heating element circuit placed next to a diffusion element of a silicon wafer and intended to diffuse material from the diffusion element into the silicon wafer. The diffusion value of the silicon wafer can be read out as the current PUF output. To reconfigure the PUF state, the heating element is turned on for enough time to alter the diffusion state to sufficiently alter sensor 110 read-out value.

Since the diffusion state can be altered by heat, leading to a change in the response of the PUF, the PUF can be utilized as a further protection against excessive temperatures. In particular, exposure of the PUF to a particular temperature, for example above a set temperature threshold, leads to failure of authentication. This, in turn, can be used to prevent a user from operating the system to which the PUF is applied. Together with the passive thermal sensor, this can provide further protection against excessive heat exposure. It is also effectively impossible to reverse the process and revert to the original key, such that this is an effective guard against attempts to hide excessive heat exposure. In other or additional embodiments, other events which alter the diffusion state may be monitored using a PUF.

The PUF unit may also be utilized as an anti-counterfeiting measure for the system. Indeed, the unique characteristics of each PUF enables verification of the authenticity of the system, and to detect potential tampering or cloning attempts. The unique encryption value may be embedded in the silicon wafer such that a diffusion reaction corrupts the unique encryption value. In this way, the unique encryption value stored in the silicon wafer may be destroyed directly by exposure to environmental conditions outside of the intended operation range of the system.

The local controller 150 may, in some cases, be further configured to control the reader 120 to generate the signal. That is, the local controller 150 may operate the reader 120 to measure the electrical property and generate the signal based on the electrical property. For example, when bi-directional communication is facilitated by the communication interface 130, the local controller 150 may control the reader 120 to generate the signal responsive to the communication interface 130 receiving the instruction from the host controller 140.

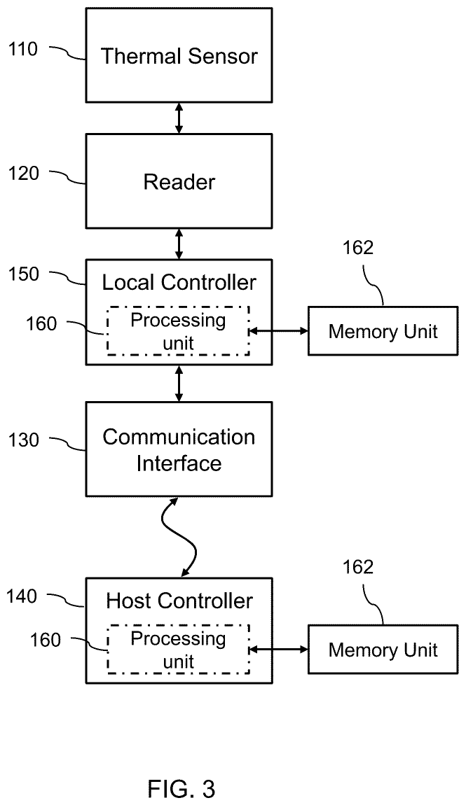

FIG. 3 depicts a further block diagram of a system for monitoring thermal exposure events. The system comprises a thermal sensor 110, a local controller 150, a reader 120, and a communication interface 130. In this case, at least one of the local controller 150 and/or the host controller 140 further comprise a processing unit 160 for processing of the signal. The processing units 160 comprise a communicatively coupled memory unit 162. Repeated description of the thermal sensor 110, reader 120 and communication interface 130 is omitted here for sake of brevity.

More specifically, the processing unit 160 is configured to process the signal to determine thermal cycle data including the cumulative count of the thermal cycles. The processor may also process the signal to determine thermal exposure data including recorded occurrences of thermal exposure events.

The signal may be received by the host controller 140 from the communication interface 130 and processed by a processing unit 160 of the host controller 140 or may be passed to an external processor for processing. For example, the host controller 140 may pass the signal to the cloud for cloud-based processing. Alternatively, the signal may be processed locally (to the reader 120 and communication interface 130) by the local controller 150 before the resulting data is passed to the communication interface 130 for transmission to the host controller 140. In some cases, a combination of these processing approaches may be taken, with some processing performed by processing unit 160 of the local controller 150, and further processing performed by the processing unit 160 of the host controller 140.

When the thermal sensor 110 is placed in proximity to a component to be monitored (e.g., a medical device, an automotive part, etc.), the processing unit 160 may be configured to analyse the thermal cycle data to generate component data describing a condition of the component. For example, a state of the component may be determined, alerts may be generated, faults detected/identified, actions suggested and/or enacted, and so on by processing of the thermal cycle data extracted from the signal. Each of this determined data may be provided to a user or may be used to inform further actions.

To this end, the processing unit 160 may be configured to analyse the thermal cycle data using a machine-learning algorithm trained to receive thermal cycle data and output component data based on the received thermal cycle data. Machine learning based algorithms may be trained to receive thermal cycle data describing exposure of a component to heat over time, and a condition of the component. These algorithms may include machine learning models such as neural networks, support vector machines, decision trees, or ensemble methods. The condition of the component may be represented by various indicators such as performance metrics, physical measurements, or categorical labels indicating the component's operational status.

The training process for these algorithms may involve supervised learning techniques, where the model is presented with historical thermal cycle data paired with known component conditions. In some cases, the algorithm may learn to identify patterns and correlations between specific thermal exposure profiles and resulting component conditions. The trained model may then be capable of predicting the condition of a component given new thermal cycle data.

In some implementations, deep learning architectures such as convolutional neural networks (CNNs) or recurrent neural networks (RNNs) may be employed to process complex temporal patterns in the thermal cycle data. These models may be particularly effective in capturing long-term dependencies and cyclic patterns in the temperature exposure history.

The AI-based algorithms may also incorporate feature engineering techniques to extract relevant information from the raw thermal cycle data. This may include calculating statistical measures, identifying peak temperatures, quantifying thermal shock events, or deriving custom metrics that capture the cumulative effect of heat exposure over time.

In some aspects, the algorithms may be designed to handle multi-modal input, combining thermal cycle data with other relevant information about the component, such as its age, maintenance history, or operational parameters.

In other embodiments, the processing unit 160 is configured to analyse the thermal cycle data based on a digital twin model configured to emulate behaviour of the component.

A digital twin is a virtual representation or simulation of a physical object, system, or process. In some aspects, the digital twin may be designed to accurately reflect the characteristics, behaviour, and performance of its real-world counterpart. The digital twin may incorporate data from various sources, including sensors, historical records, and real-time inputs, to create a dynamic and up-to-date model. Accordingly, a digital twin of the component may be used to analyse characteristics of the component that is subject to thermal conditions described by the thermal cycle data

The memory unit 162 is configured to store the determined thermal cycle data. Furthermore, the memory unit 162 may be configured to store the generated component data. The memory unit 162 may also store the signal for analysis by the processing unit 160 when required. The memory unit 162 may include various types of storage devices capable of storing data and instructions for processing. These devices include, but are not limited to, random access memory (RAM), read-only memory (ROM), flash memory, solid-state drives (SSDs), hard disk drives (HDDs), and optical drives. In some cases, hybrid storage solutions may combine multiple memory types to provide a memory unit 162, such as SSDs and HDDs, to balance performance and capacity.

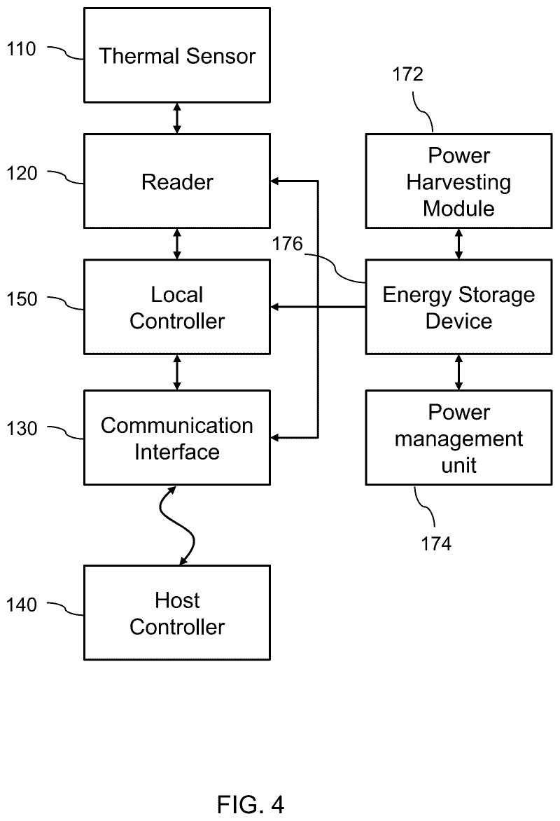

FIG. 4 depicts another block diagram of a system for monitoring thermal exposure events. The system comprises a thermal sensor 110, a local controller 150, a reader 120, and a communication interface 130. In this case, the system further comprises an energy storage device 176, a power harvesting module 172, and a power management unit 174. Repeated description of the thermal sensor 110, reader 120, local controller 150 and communication interface 130 is omitted here for sake of brevity.

In particular, the power harvesting module 172 is configured to obtain power for the reader 120, communication interface 130, and/or the local controller 150. That is, the power harvesting module 172 may generate/receive power that can be used to power various components of the system. The power harvesting module 172 may be incorporated into the system to capture and utilize ambient energy sources. The power harvesting module 172 may include various components and technologies to convert different forms of environmental energy into usable electrical power.

For example, piezoelectric elements may be incorporated into the power harvesting module 172. These components may convert mechanical stress or vibrations into electrical energy. The piezoelectric elements may be strategically placed to capture energy from movement, pressure changes, or vibrations in the surrounding environment.

In some implementations, the power harvesting module 172 may utilize electromagnetic induction. This may involve coils or antennas designed to capture energy from ambient electromagnetic fields, such as those generated by wireless communication networks or power transmission systems. Specifically, radio frequency (RF) energy harvesting may be an option for the power harvesting module 172. This approach may involve specialized antennas and circuits designed to capture and convert RF signals from various sources, including Wi-Fi, cellular networks, or dedicated RF transmitters, into usable power. More particularly, the power harvesting module 172 may utilize power from signals provided by the host controller 140.

The power harvesting module 172 may also incorporate kinetic energy harvesting mechanisms. These may include components such as pendulums, flywheels, or other motion-based systems that can convert movement or vibrations into electrical energy.

In some implementations, the power harvesting module 172 may incorporate thermal energy harvesting capabilities. This approach may utilize thermoelectric generators (TEGs) to convert temperature differences into electrical energy. The TEGs may be composed of materials with high thermoelectric properties, such as bismuth telluride or lead telluride.

The thermal energy harvesting system may be designed to capture heat from various sources in the environment. These sources may include ambient air temperature, body heat, industrial processes, or even solar thermal energy. The system may employ heat sinks or thermal collectors to maximize the temperature gradient across the thermoelectric materials.

In some cases, the power harvesting module 172 may employ multiple harvesting technologies simultaneously, potentially increasing the overall energy capture efficiency. The module may also include power management circuitry to regulate and store the harvested energy, ensuring a stable power supply for the device's operations.

The energy storage device 176 is configured to store the obtained power for the reader 120 and/or the communication interface 130. The energy storage device 176 may include various types of systems designed to store and release energy as needed. The energy storage device 176 may comprise batteries, which can store electrical energy through electrochemical processes (e.g., lithium-ion, lead-acid, or nickel-metal hydride batteries). In some cases, the energy storage device 176 may include capacitors or supercapacitors, which can rapidly store and release electrical energy.

The power management unit 174 is configured to control power provided to the reader 120, the communication interface 130, and/or the local controller 150. That is, the power management unit 174 controls flow of power between the power harvesting module 172 and the energy storage device 176 and is configured to control flow of power from the energy storage device 176 to the various powered components of the system.

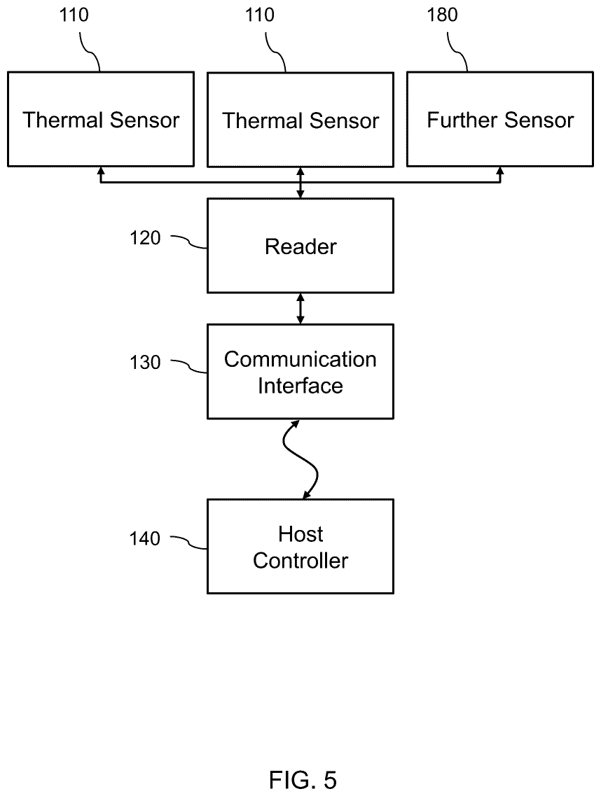

FIG. 5 depicts a further block diagram of a system for monitoring thermal exposure events. The system comprises a plurality of passive thermal sensors 110, and optionally further sensors 180. Repeated description of the reader 120, and communication interface 130 is omitted here for sake of brevity.

In particular, each of the plurality of passive thermal sensors 110 are configured to detect an occurrence of thermal cycles and record a cumulative count of thermal cycles via alteration of an electrical property of the respective thermal sensor 110. Each alteration of the electrical property is non-transient. This system enables monitoring of thermal conditions in multiple locations, and/or may provide additional redundant monitoring of the thermal conditions in one location.

Each further sensor 180 may be configured to monitor parameters other than thermal events. For example, the further sensor may be a motion sensor, a pressure sensor, a humidity sensor, a light sensor, a proximity sensor, force sensors etc. Of course, the further sensor 180 may be chosen to suit the application of the thermal exposure monitoring system. The output from such sensors may also be used to determine component characteristics
using the machine learning based algorithm and/or the digital twin as described above.

To be clear, whilst depicted in different figures, any combination of components described above may be provided as part of the system for thermal cycle counting and/or thermal exposure event monitoring. That is, embodiments may comprise any combination of the local controller 150, host controller 140, processing unit 160, memory unit 162, energy storage device 176, power harvesting module 172, power management unit 174, and additional sensors, in addition to the thermal sensor 110, reader 120 and communication interface 130.

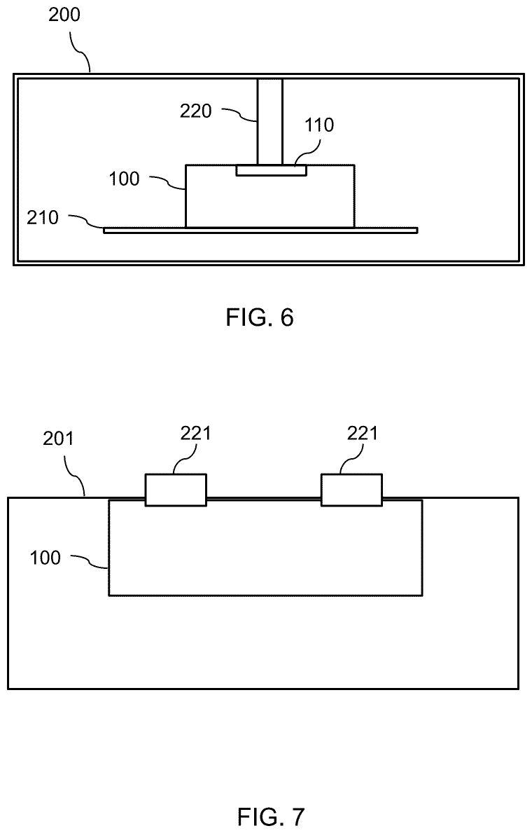

FIG. 6 depicts a simplified cross-section of a system 100 for monitoring thermal events and/or for thermal cycle counting integrated in a casing 200. Specifically, the thermal sensor 110, and optionally the reader 120 and/or the communication interface 130 are provided in a casing 200.

More particularly, the casing 200 is configured to house the thermal sensor 110, reader 120, and/or communication interface 130. The casing 200 may comprise a printed circuit board (PCB) 210 upon which the system 100 including the thermal sensor 110, reader 120, and/or communication interface 130 are provided. The system 100 may thus be assembled on a PCB 210 within the casing 200.

To be clear, the system including the thermal sensor 110, reader 120, and/or communication interface 130 may be provided as discrete semiconductor components or custom application specific products arranged on a PCB 210. The system may include the thermal sensor 110, reader 120, and/or communication interface 130 fully integrated as a custom semiconductor system on chip provided on the PCB 210.

In some embodiments, and as depicted, the casing 200 may be hermetically sealed. This means that the thermal sensor 110, reader 120, and/or communication interface 130 may be protected by the casing 200 against exposure to fluid and other debris. In other cases, the casing 200 may be non-hermetic, meaning that the system may be exposed to environmental conditions. In this case, the casing 200 has vents allowing the movement of fluid and/or debris in and out of the casing 200.

The casing 200 further comprises a thermal conduit 220 configured to transfer heat from outside the casing 200 to the thermal sensor 110. This may be particularly important when the casing 200 is hermetically sealed. The thermal conduit 220 may be provided in the form of a thermal heat pipe.

Furthermore, the casing 200 may be tolerant to chemicals. This may be beneficial, for example, when the system is used for monitoring autoclaving where medical equipment is exposed to chemicals (such as vaporized hydrogen peroxide and ethylene oxide) for sterilization of equipment. Of course, the specific level of tolerance required may be dependent upon the application of the monitoring system and the chemical involved in such applications.

In additional embodiments, the casing 200 may be tolerant to radiation from gamma, x-ray, and/or e-beam sources, for example. This may ensure that the thermal sensor 110, reader 120, and/or communication interface 130 are protected from these sources of radiation. Additionally, or alternatively, the thermal sensor 110, reader 120, and/or communication interface 130 themselves may each be tolerant to radiation from these sources. Similarly to the above, this may be beneficial, for example, when the system is used for monitoring autoclaving which uses sources of radiation for sterilization purposes.

FIG. 7 depicts a further simplified cross-section of a system 100 for monitoring thermal events and/or for thermal cycle counting integrated in a casing 201. Specifically, the thermal sensor 110, and optionally the reader 120 and/or the communication interface 130 are provided in the casing 201.

Similarly to the casing 200 of FIG. 6, The casing 201 is configured to house the thermal sensor 110, reader 120, and/or communication interface 130. In the depicted case, exposed thermal contacts 221 are provided. These thermal contacts 221 are configured to connect the thermal sensor 210 to the surrounding environment or the component to be monitored.

In other words, the system 100 including the thermal sensor can be contained in a package/casing 201 that can be embedded or mounted within or on a component/object of interest. Exposed contacts 221 ensure that the thermal conditions of the surroundings are appropriately conveyed to the thermal sensor 110.

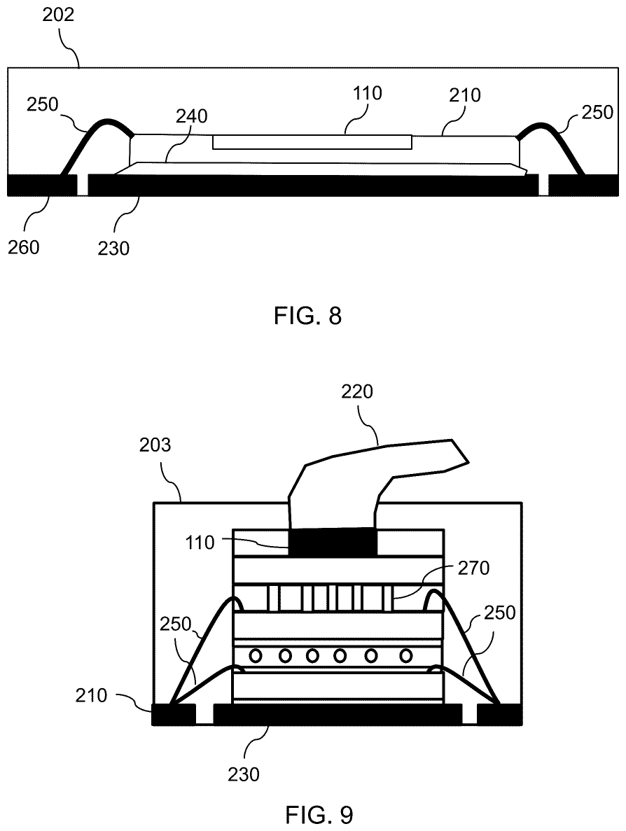

FIG. 8 depicts another simplified cross-section of a system 100 for monitoring thermal events and/or for thermal cycle counting integrated in a casing 202. Specifically, the thermal sensor 110, and optionally the reader 120 and/or the communication interface 130 are provided in the casing 202.

In the presented case, the thermal sensor 110 is provided on a PCB 210 in a cavity of the casing 202. The PCB is connected, via die attach 240, to an exposed paddle 230 of the casing 202. The exposed paddle 230 is shaped such that there is provided a path for heat to flow to the thermal sensor 110.

The thermal sensor is attached to external leads and/or connections 260 via bond wires 250.

The casing 202 may be provided in the form of a quad-flat no-lead (QFN) type package, a leadframe-based chip scale package (LFCSP), a leadless chip carrier (LCC) made from ceramic material, or any other package.

Although not depicted, there could be more dies included and mounted in the casing 202, for example dies corresponding the reader 120 and/or the communication inface 130. The casing 202 could also comprise one or more heatsinks, heat slugs and other thermal conduits to better thermally couple the thermal sensor 110 to the surrounding environment, and to optimize the required response depending on the specific requirements of the application.

FIG. 9 depicts an additional simplified cross-section of a system 100 for monitoring thermal events and/or for thermal cycle counting integrated in a casing 203.

The thermal sensor 110 is provided, along with various other processing circuitry (such as a reader 120, encryption hardware and AI processors), interconnecting layers 270, and communication circuitry (such as a communication interface 130). These components are provided in the form of a stacked die. Nevertheless, the components may include through-silicon vias (TSVs), laminates, flex, chiplets, etc. The thermal sensor 110 and other circuitry is attached to external leads and/or connections 260 via bond wires 250.

In the presented case, the thermal sensor 110 is provided in a cavity of the casing 203. The PCB is mounted on an exposed paddle 230 of the casing 202. The exposed paddle 230 is shaped such that there is provided a path for heat to flow to the thermal sensor 110. Furthermore, there is provided a thermal conduit 220 providing thermal connection to the environment outside the casing 203.

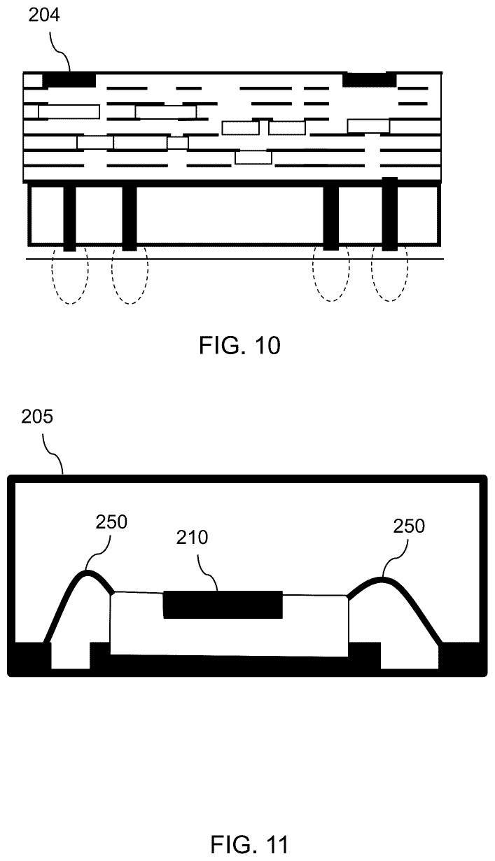

FIG. 10 depicts another simplified cross-section of a system 100 for monitoring thermal events and/or for thermal cycle counting integrated in a casing 204.

FIG. 11 depicts a further simplified cross-section of a system 100 for monitoring thermal events and/or for thermal cycle counting integrated in a casing 205. The casing 205 is similar to the casing 202 depicted in FIG. 8. However, in contrast, casing 205 is hermetically sealed. This means that the thermal sensor 110, an any other included components may be protected by the casing 205 against exposure to fluid and other debris.

The casing 205 may be a ceramic-based package. Alternatively, the casing 205 may be a metal can type package (e.g., Alloy42), which may be particularly suited for harsh environments.

Although not depicted, the casing 205 may further comprise thermal conduits such that the thermal sensor 110 is exposed to heat of the surrounding environment despite the hermetic seal of the casing 205.

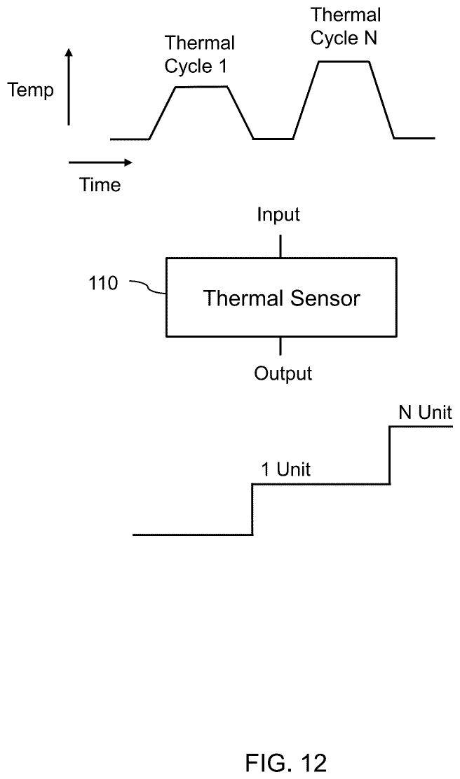

FIG. 12 graphically represents how proposed embodiments of the thermal sensor 110 detects and converts thermal cycle inputs into an output response. In the depicted case, the thermal sensor detects the thermal cycles, which present as temperature increases for lengths of time. This results in an electrical characteristic change of the thermal sensor, such that there may be exhibited a unit step response change in the electrical characteristic upon interrogation by a reader 120, for example. The time and temperature of the thermal cycles may be specified within a range and the output response may include a 1-unit response for each cycle within the range, with a cumulative 1-unit response at the output to correspond to the total number of cycles detected.

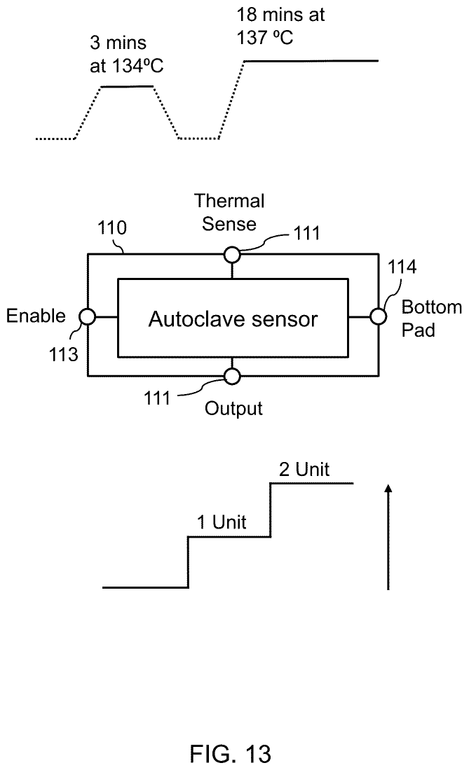

A specific example of the thermal sensor 110 is shown in FIG. 13, which may be applied to autoclave cycle counting. In particular, the autoclave counter sensor 110 counts the number of times the temperature rises between 132 °C to 137 °C for at least 3 minutes (i.e., an autoclave cycle). As shown, this occurs twice, as detected by the thermal sense pin 111. The number of times this thermal cycle has been detected may be identified by interrogating the output pin 112 of the autoclave sensor 110. Each detection of a thermal cycle within this range for this time by the sensor results in a step change in the output of the autoclave sensor 110. Accordingly, a reader may derive the number of autoclave cycles detected by the autoclave sensor 110 based on the step response output. Of course, reconfiguration of the temperature range and time-at-temperature may be altered to suit the particular application. Furthermore, the autoclave sensor 110 may comprise an enable pin 113 to allow detection and recording of the thermal cycles, and a bottom pad 114 to provide a voltage reference.

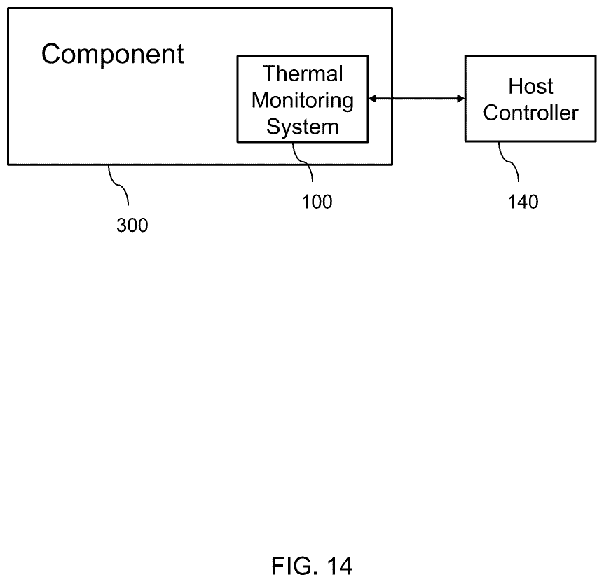

FIG. 14 presents a simplified example of an application of the thermal monitoring system 100. As shown, the thermal monitoring system 100 as described herein may be integrated with, provided on, or positioned near to a component 300. Accordingly, the thermal monitoring system may detect and record the occurrence of thermal events experienced by the component. For example, the thermal monitoring system 100 may count the number of thermal cycles experienced by the component 300.

The thermal monitoring system 100 may communicate the thermal data to a host controller 140 via either a wired or wireless connection. The host controller 140 may be a fixed machine terminal, or a portable device. The host controller 140 may therefore receive information regarding the thermal events experienced by the component 300.

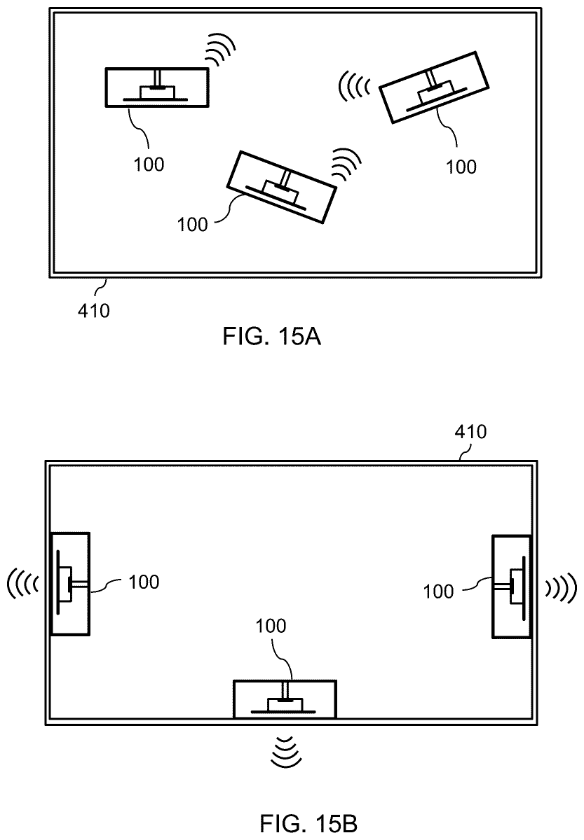

FIGS. 15A and 15B depict two examples of further application of the thermal monitoring system 100. Specifically, these depict the monitoring of thermal events in a container 410, such as a vat of high value liquid used pharmaceutical/chemical industries. There may be provided several thermal sensors, or full thermal monitoring systems 100 provided within the container 41—of the fluid. In FIG. 15A, the thermal monitoring systems 100 may be allowed to move freely within the liquid and may be suspended within the liquid. To this end, these systems may require wireless communication with a host controller. In FIG. 15B, the thermal monitoring systems may be placed at specific locations within the container 410 and may communicate with a host controller via wired or wireless connections. The thermal monitoring systems 100 may be hermetically sealed to prevent the ingress of the fluid in the container 410.

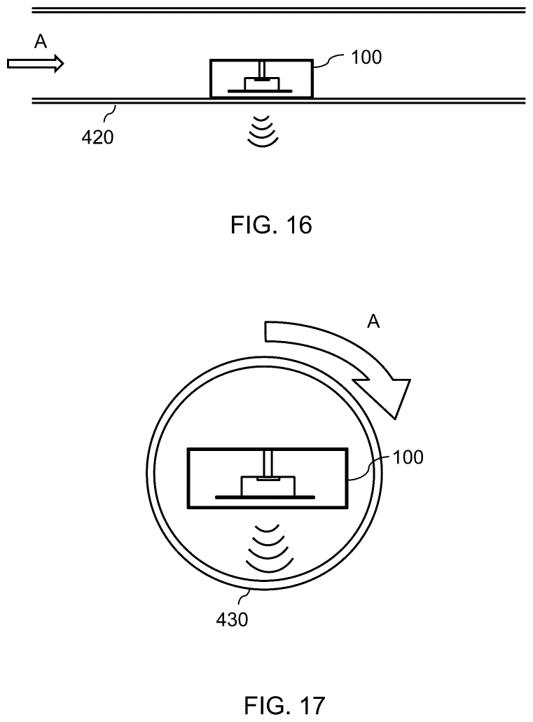

FIG. 16 depicts another example of an application of the thermal monitoring system 100. In particular, the thermal monitoring system 100 may be provided to monitor thermal events in a fluid pipe 420, with fluid moving in the direction depicted by arrow A. In other words, the thermal monitoring system 100 may detect thermal events (and perhaps other properties, such as pressure, humidity, etc.) at a critical junction within a fluid transportation system 420. The thermal monitoring system 100 may be fixed to the side of the fluid pipe 420 as depicted, or may be allowed to travel through the fluid pipe 420.

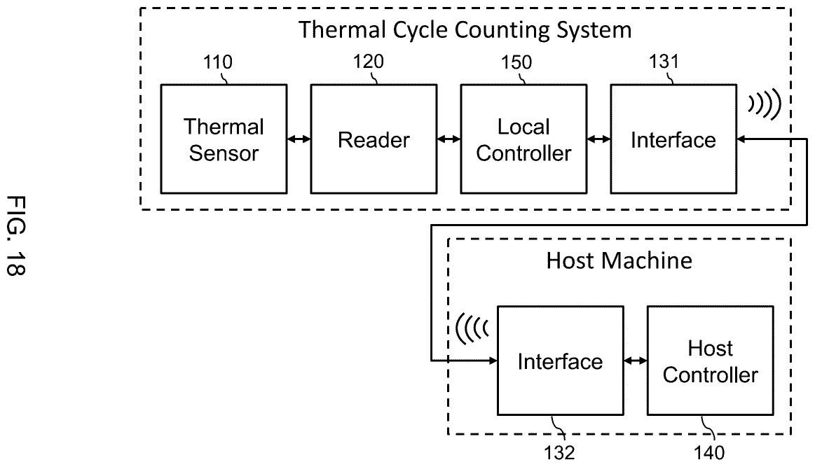

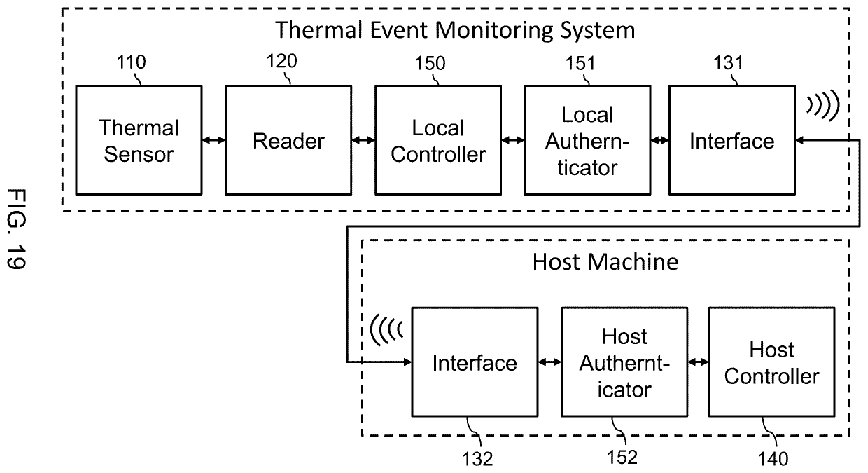

FIG. 17 depicts a further example of an application of the thermal monitoring system 100. In particular, the thermal monitoring system 100 may be provided to monitor thermal events in a rotating component 430 (e.g. moving in the direction depicted by arrow A). To this end, the thermal monitoring system 100 may comprise a turn position sensor. Moving component 430 may be more likely to experience high stress and excessive temperatures, and therefore monitoring of a moving part 430 may be achieved by integration of a thermal monitoring system 100. The additional integration of a turn position sensor may enable full appreciation of the conditions in which certain thermal events are triggered.

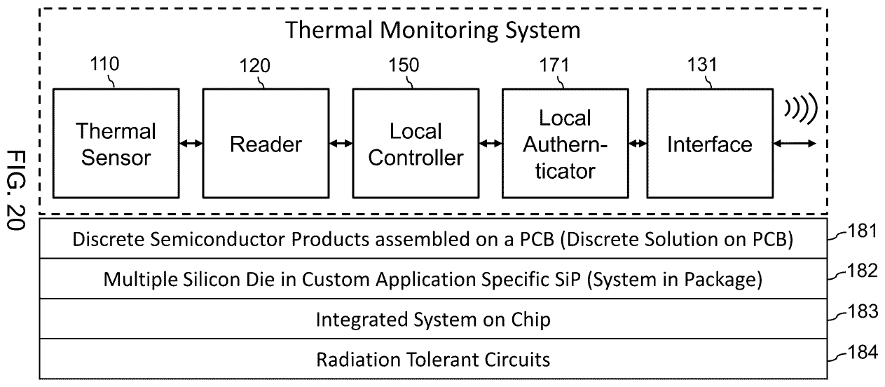

FIG. 18 depicts a block diagram of a system for thermal cycle counting according to an embodiment of the invention. The thermal sensor 110 operates with passive autonomy to detect and record a cumulative count of the number of thermal cycles. The thermal sensor 110 may be configured, for example, to count autoclave cycles. The cumulative count may be deduced electronically when connected to a host machine. The host controller 140 may initiate a data communication and low power link with the thermal cycle counting system by wired (e.g., 1-Wire) and/or wireless (e.g., RFID/NFC) interfaces 131, 132. The local controller 150 in the thermal cycle counting system may communicate with an electronic reader 120 to take a read out of the cumulative count stored in the form of a physical characteristic change of the thermal sensor 110. The reader 120 may be a discrete precision analog to digital converter frontend or a custom frontend may be integrated on silicon with the thermal sensor 110 and/or the local controller 150. The interfaces 131, 132 may include energy harvesting features to transfer low power from the host machine to the thermal cycle counting system to initiate a read out of the sensor output response.

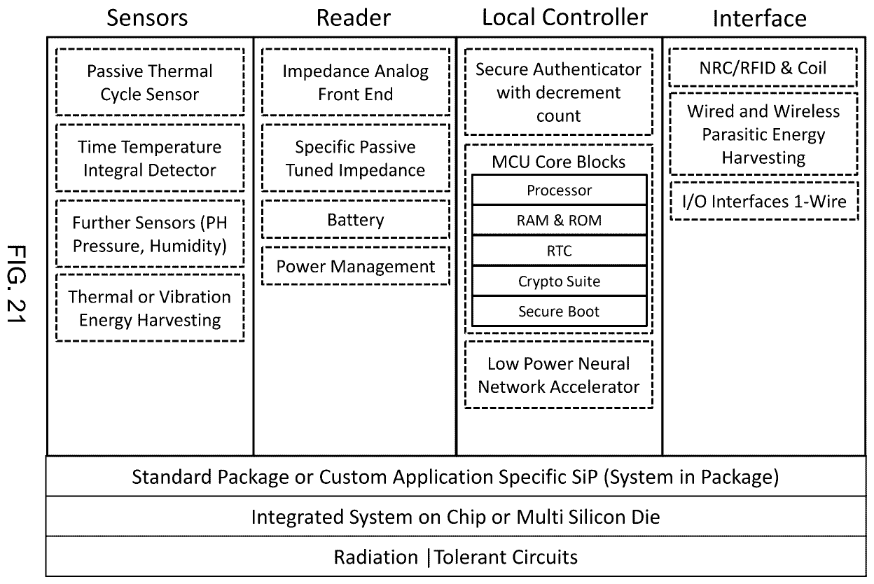

FIG. 19 depicts a block diagram of a system for monitoring thermal events. Similarly to the system of FIG. 13, there is provided a thermal sensor 110, reader 120, local controller 140, interfaces 131, 132, and a host controller 140. In this case, secure authenticators 151, 152 are included that may provide usage control functions and prevent counterfeiting and cloning. The authenticators 151, 152 may be used to provided security features including bi-directional authentication, secure memory, encrypted system calibration data storage, secure use counting, and system session key generation.

The authenticators 151, 152 may include a decrement counter feature to register and record each time the thermal event monitoring system connects to the host machine (or more specifically, the host controller 140). For example, in the case that the thermal event monitoring system is used for autoclave cycle counting of surgical equipment, this connection would typically occur at the start of each surgery, so the decrement counter may be used to estimate a number of surgeries undertaken by the instrument. The system would therefore have the capability to record a cumulative count of the autoclave cycles undertaken on the surgical device, as well as the number of surgeries in which the surgical device has been employed. This may provide an improved insight into the usable lifetime of the surgical device.

FIG. 20 presents integration and implementation options for the thermal monitoring systems described in relation to FIGS. 18 and 19. The subsystems (i.e., the thermal sensor 110, reader 120, etc.) of the thermal monitoring systems may be implemented as discrete standard semiconductor components, or custom application specific semiconductor products (ASICs) arranged and assembled on a PCB 181. Alternatively, the subsystems may be implemented as discrete standard or custom semiconductor die co-packaged in one or more custom semiconductor packages 182. As yet another alternative, the subsystems may be fully or partially integrated as a custom semiconductor system on chip with one or more subsystems manufactured on one or more semiconductor dies 183. The subsystems may be all or in part tolerant to radiation from gamma, x-ray, and/or e-beam sources 184.

FIG. 21 presents various options for components that may be implemented as part of the various subsystems of FIGS. 18 and 19. As shown, the sensor subsystem comprises the passive thermal cycle sensor, and may also include a time temperature integral detector. The sensor subsystem may further include additional sensors, such as pressure, humidity, PH, position sensors, and equipment for harvesting thermal and/or vibration energy sources.

The reader subsystem may comprise an impedance analog front end to read the physical characteristic of the thermal sensor. This may also comprise a specific passive tuned impedance for comparison to the physical characteristics of the thermal sensor. Further, there may be provided battery and power management modules to provide and control power flow. The local controller may comprise a secure authenticator unit, including a decrement count. The local controller may comprise standard MCU core blocks, and/or a low power neural network accelerator for processing information from the reader.

Finally, the communication interface may comprise wired and wireless parasitic harvesting capabilities for receiving energy from, for example, the host controller. There may be provided wireless communication systems such as NFC and/or RFID. There may alternatively, or additionally, be provided an I/O interface for wired communication.

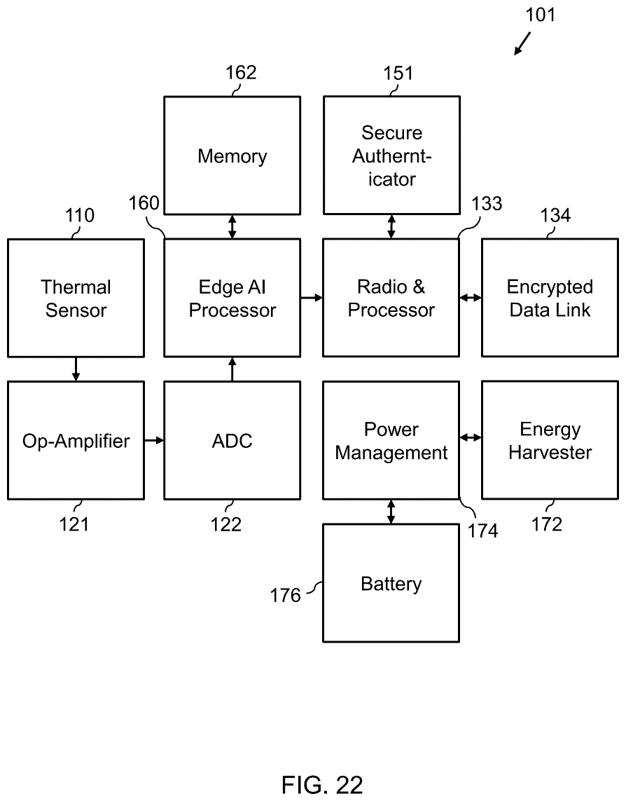

FIGS. 22-27 provide various simplified block diagrams of thermal monitoring systems adapted for a variety of applications.

The thermal monitoring system 101 depicted in FIG. 22 may be particularly suited for predictive maintenance of critical machinery, such as pumps, motors, etc. Mechanical faults in such machines result in significant temperature increases, which may damage and lead to premature loss of such machinery by annealing bearings and reducing hardness of materials.

A thermal sensor 110 is provided to detect and record thermal events (e.g., to count thermal cycles) of the component of the critical machinery. The function of the thermal sensor 110 may be adapted to be suited for recording a range of expected thermal events for the critical machinery.

An op-amp 121 and ADC 122 are provided to read an electrical characteristic of the passive thermal sensor 110, and to provide a digital signal to an edge AI processor 160 describing the electrical characteristic.

The edge AI processor 160 may be adapted learn machine behaviour over time. To this end, a map of typical machine behaviour may be stored in memory 162 that is reusable for similar machines. The edge AI processor 160 can be used to process data from the thermal sensor 110 (provided via the op-amp 121 and ADC 122), and to determine whether such data indicates that thermal events experienced by the machine should be flagged and/or determines appropriate action. The memory 162 may store data from the sensor 110 and data produced by the edge AI processor 160. In some cases, wired or wireless networks may not be permitted to be deployed. In this case, the memory 162 may provide flexibility to install the thermal monitoring system.

A radio and processor 133 provide a wireless means for communicating, via encrypted data link 134, the data from the thermal sensor 110 and/or information generated by the edge AI processor 160. This enables straightforward installation, without the need for cabling to communicate the data. The encrypted data link 134 may be established with a radio and processor associated with a host controller (not depicted), for example. Further, the secure authenticator 151 mitigates issues with unauthorized aftermarket imitations of the thermal monitoring system. In addition, the secure authenticator 151 may ensure data from the thermal sensor is cryptographically secured.

An energy harvester 172 is provided for this application to take advantage of the high temperature environment. Power management 174 is provided to trickle charge from the battery 176 (or other energy storage device) and energy harvester 172 to various other components of the system. Accordingly, the need for an external power source and wired link to such a power source may be obviated.

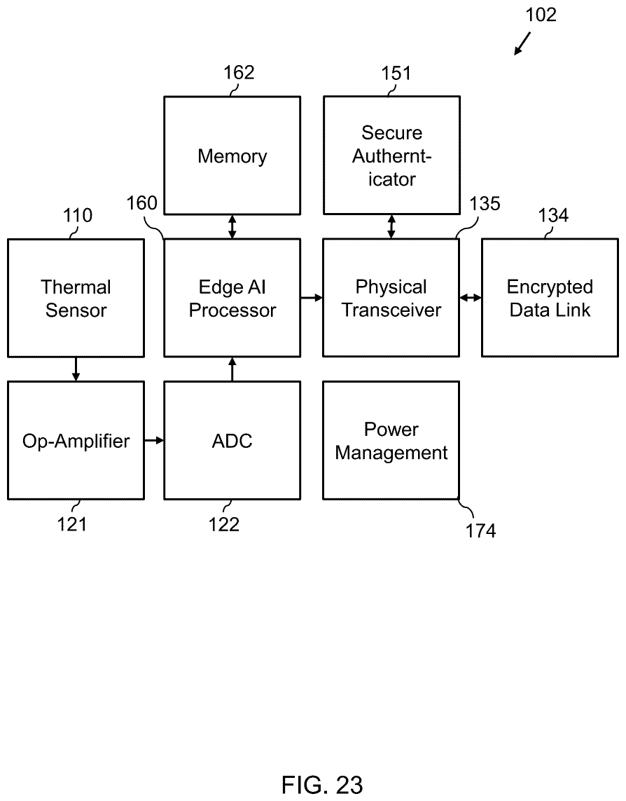

The thermal monitoring system 102 depicted in FIG. 23 may be particularly suited for predictive maintenance of machinery that requires fast, real-time fault detection and control. Many of the components of the thermal monitoring system 102 and their functionality may be similar to those employed in the thermal monitoring system 101. Repeated description is therefore omitted for sake of brevity.

However, in contrast to the thermal monitoring system 101, a physical transceiver 135 is provided. The physical transceiver 135 may comprise one or more wires, for example. The physical transceiver 135 may enable communication of data generated by the edge AI processor and/or data from the thermal sensor 110, via an encrypted data link 134, to a host controller. Whilst the need for physical cabling may increase complexity of installation, the physical transceiver 135 may enable real-time monitoring and control, avoiding delays and potential errors associated with wireless links. Therefore, a decision regarding the machine fault condition may be made more rapidly.

Furthermore, the physical transceiver 135 may provide a constant power source for various components of the thermal monitoring system 102. This may mean that the system 102 does not require an energy harvester or battery. Instead, power received by the physical transceiver 135 may be managed by the power management unit 174 to ensure appropriate provision of power to the various components.

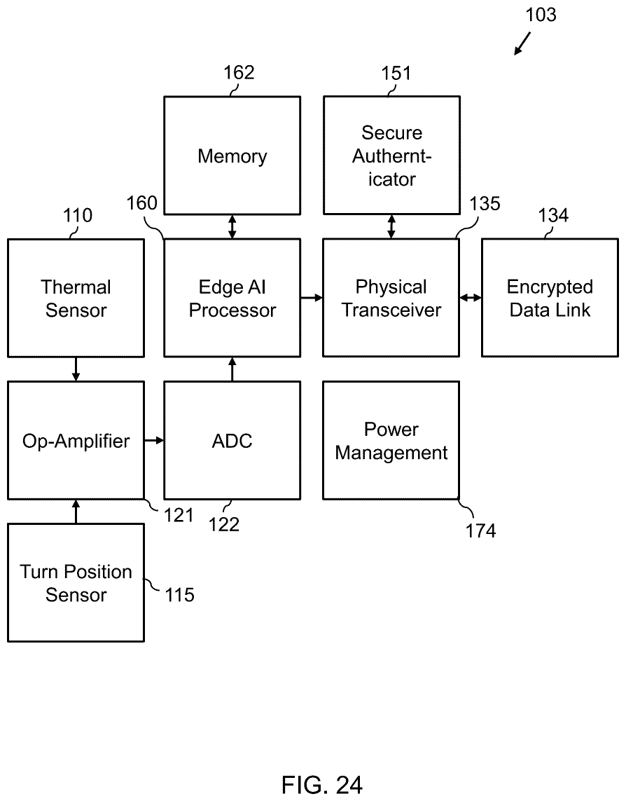

The thermal monitoring system depicted in FIG. 24 may be particularly suited for precise understanding of the operation of certain machinery, such as robotics. Many of the components of the thermal monitoring system 103 and their functionality may be similar to those employed in the thermal monitoring systems 101 and 102. Repeated description is therefore omitted for sake of brevity.

However, the thermal monitoring system 103 further comprises a turn position sensor 115 configured to determine a rotational position of the component for which the thermal monitoring system 103 is deployed. The fusion of the data from the turn position sensor 115 and the thermal sensor 110 may enable improved understanding of the conditions by which certain temperature increases occur. The thermal events detected by the thermal sensor 110 can be used to determine if the failure of the machinery is caused by a temperature trend increase, or by other sources. This analysis may be performed by the edge AI processor 160, or may be performed by an external processor.

Furthermore, the depicted thermal monitoring system 103 may provide for tracking of the machinery even when power is not available, which is critical for system continuity and safety. Indeed, as described previously, the thermal sensor 110 is passive and therefore does not require power to detect and record thermal events.

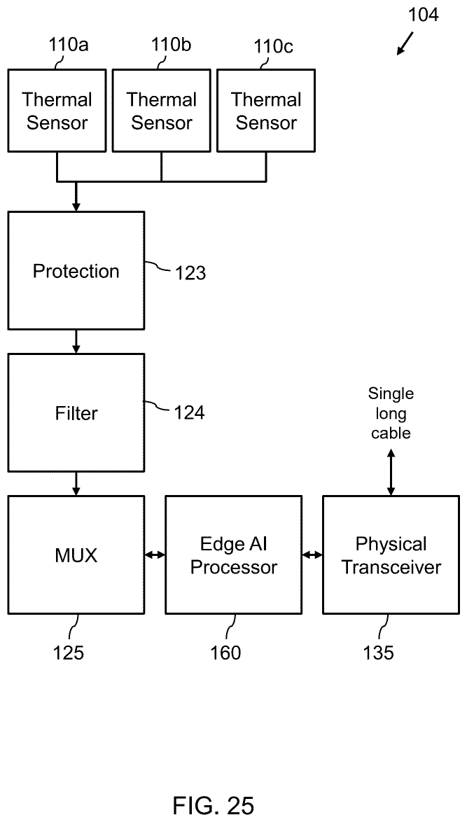

The thermal monitoring system 104 depicted in FIG. 25 may be particularly suited for automotive applications. More specifically, the depicted thermal monitoring system 104 may be particularly suited for monitoring exhaust gas systems, engine management, transmission management, HEV-EV temperature monitoring, and monitoring body modules.

The thermal sensors 110a-110c may be provided at critical parts of the vehicles (e.g., on an engine or braking system). Each thermal sensor 110a-110c may individually be provided at different critical parts of the vehicle, or may be provided at the same critical part of the vehicle in order to provide redundancy. Protection 123 and filter 124 may be provided to shield the thermal sensors 110a-110c from damage (e.g., physical damage from moving parts, fluids, etc.), and to ensure that any noise due to turbulent conditions is mitigated.

A multiplexer 125 is also provided to sequentially and/or selectively output read data from each of the thermal sensor 110a-110c, and provide such data to the edge AI processor 160. The edge AI processor 160 may provide the thermal data from the thermal sensors 110a-110c, and any data generated by processing such thermal data, to a physical transceiver 135 for communication (e.g., to a host controller) by a single long cable. Thus, rather than running long cables back to a central monitoring unit with the potential for errors and common mode voltages to manage, multiple thermal sensors 110a-110c are provided with only one bulk cable.

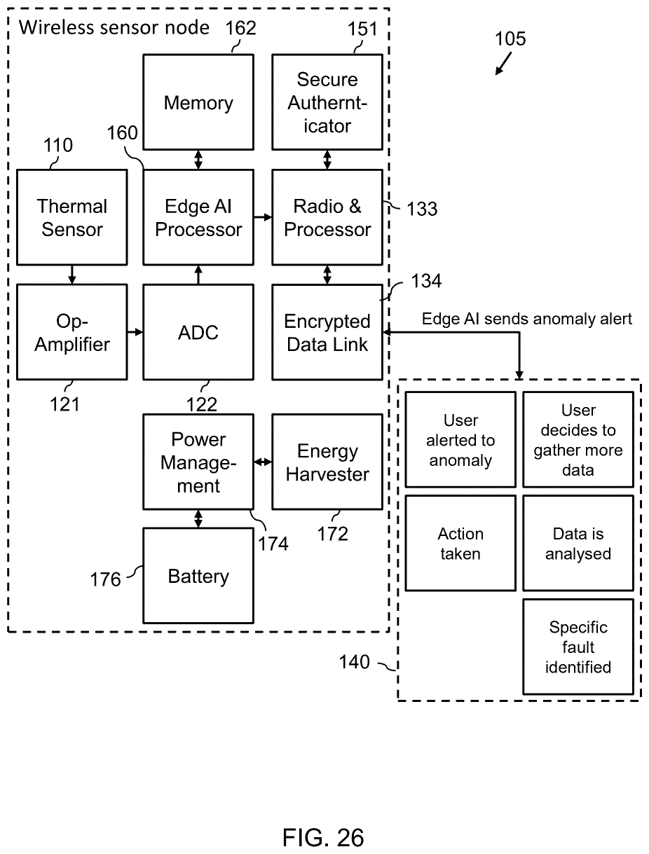

FIG. 26 depicts a thermal monitoring system 105 with an encrypted data link 134 to a host controller 140. Specifically, the thermal monitoring system 105 is provided as a wireless sensor node with local processing of the thermal data produced by a thermal sensor 110 by an edge AI processor 160. That is, the edge AI processor 160 may locally process the thermal data to identify anomalies, determine faults, and/or identify appropriate actions to be taken. To be clear, many of the components of the wireless sensor node depicted in FIG. 21 may be replaced by those in the thermal monitoring systems 101-104, as required by the specific implementation.

In any case, the edge AI processor 160 may send an alert, via the encrypted data link 134 to a host controller 140, in order to indicate the presence of an anomaly as indicated by thermal data from the thermal sensor. For example, a user may simply be alerted to the anomaly, responsive to which the user may perform actions or decide to gather more data or analyse the data further. In some cases, a specific fault in the system being monitored by the thermal monitoring system may be identified.

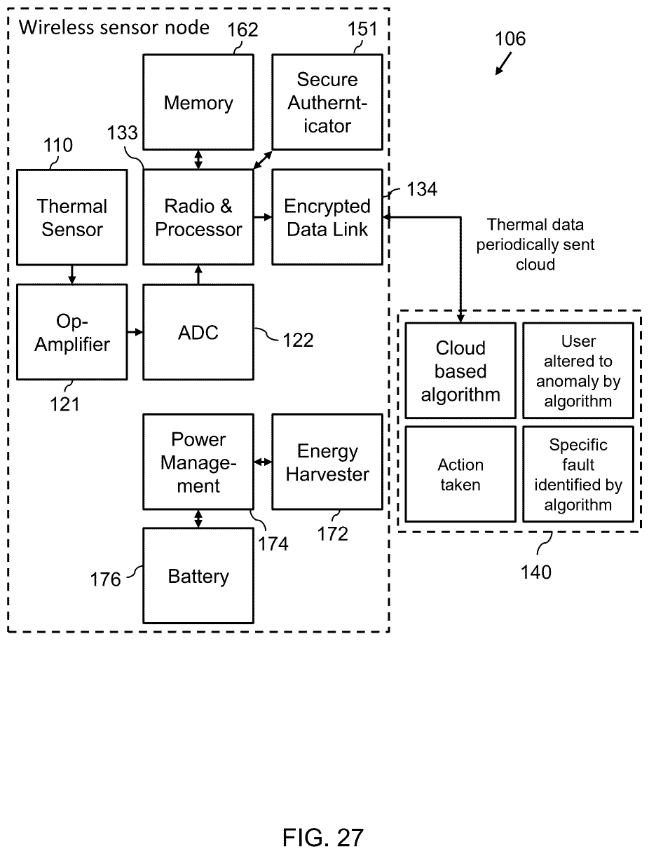

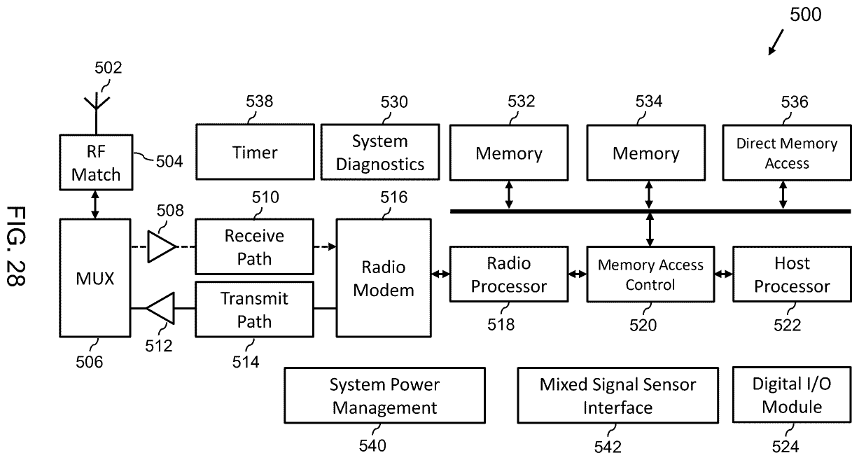

FIG. 27 depicts a thermal monitoring system 106 with an encrypted data link 134 to a host controller 140 that has a cloud-based algorithm for processing thermal data from the thermal sensor 110. In contrast to thermal monitoring system 105, a local edge AI processor is not provided. Instead, the thermal monitoring system 106 is provided as a wireless sensor node but does not process the thermal data from the thermal sensor 110 locally. The thermal data is instead periodically transmitted via an encrypted data link 134 to a host controller 140, which may exploit cloud-based processing and algorithms to identify anomalies, determine faults, and/or identify appropriate actions to be taken.

FIG. 28 is a block diagram of an exemplary communication interface 500 for communicating information from a thermal monitoring system to a host processor. The communication interface 500 provides for wireless communication between a thermal sensor and a host controller. The communication interface may be configured to transmit and/or receive data via Wi-Fi, Bluetooth, Bluetooth Low Energy (BLE), Zigbee, Thread, ANT, ANT+, IEEE 802.15.4, IEEE 802.11.ah, or any other suitable wireless communication protocol. Alternatively, or additionally, the communication interface 500 may be configured to transmit and/or receive data using proprietary connectivity protocols.

As shown, the communication interface 500 may comprise an antenna 502, an RF match 504, a multiplexer (mux) 506, amplifiers 508 and 512, receive path 510, transmit path 514, radio modem 516, radio processor 518, memory access control 520, host processor 522, digital I/O module 524, system diagnostics 530, memories 532 and 534, direct memory access 536, timer 538, system power management 540, mixed signal sensor interface 542, or any suitable combination thereof.

The antenna 502 may comprise a microstrip antenna, a loop antenna, a slot antenna, a serpentine-shaped antenna, or any other suitable type of antenna. In some embodiments, the antenna 502 may comprise one or more carbon nanotube antennas. The RF match 504 may be connected to antenna 502, and may comprise circuitry configured to provide impedance matching, and/or to provide a desired impedance. The multiplexer 506 may be configured to combine and/or separate communication channels in the time domain and/or in the frequency domain. Alternatively, or additionally, the multiplexer 506 may be configured to separate transmit signals directed to antenna 502 from receive signals obtained by antenna 502. The amplifier 508 may be configured to amplify a signal received with antenna 502. In some embodiments, a receive path 510 may be provide and may be coupled to amplifier 508. The receive path 510 may comprise a filter in some embodiments. Similarly, the transmit path 514 may comprise a filter, and may be configured to provide a transmit signal to amplifier 412. The radio modem 516 may comprise circuitry configured to modulate a signal for transmission, and/or demodulate received signals. The radio processor 518 may be configured to select the type of communication protocol, the data rate, the communication channel, the type of data to be transmitted, or any other suitable transmission parameter.

The data to be transmitted may be stored within memory 532 or memory 534. Radio processor 518 may be configured to access the data stored in any of the memories of the communication interface 500. Memory access control 520 and direct memory access 536 may be configured to access any of the memories of the communication interface 500 independently of the radio processor 518. For example, the host processor 522 may request access to the memory using direct memory access 536 without having to send an interrupt signal to radio processor 518.

The host processor 522 may be configured to control the operations of the communication interface 500. For example, the host processor 522 may control system power management 540 to place the communication interface 500 in sleep mode, thus increasing an associated battery's lifetime. The communication interface 500 may be placed in sleep mode at certain predetermined times. In some embodiments, the communication interface 500 may be placed in a sleep mode, and may wake up at regular intervals, such as once per second, to monitor if a device (such as a host controller) has provided a wake up signal. In some embodiments, the sleep/awake duty cycle may be less than 50%, less than 20%, less than 1% or less than 0.1%.

In some embodiments, the host processor 522 may be configured to perform data compression on the data obtained by the thermal sensor. For example, the compression may comprise creating a data set representing the variations in an existing data set. The compression may be performed to decrease the size of the packet, or sequence, to be transmitted.

Timer 538 may provide a time base to the communication interface 500. System diagnostics 530 may be configured to perform tests to verify the integrity of any suitable combination of the components of the communication interface 500. Mixed signal sensor interface 542 and digital I/O module 524 may be configured to provide signals obtained with one or more of the passive thermal sensors.

In some embodiments, the communication interface 500 may be configured to transmit a continuous flux of data. In such embodiments, data obtained by a thermal sensor may be transmitted in a streaming mode. In other embodiments, data may be buffered within a memory of the communication interface 500, for example memory 532 or 534. In such embodiments, a processor, such as radio processor 518 or host processor 522 may be configured to access the data buffered in the memory, and to provide the data to antenna 502 for transmission. The antenna 502 and/or any suitable component of communication interface 500 may be disposed on a substrate in some embodiments, such as a flexible substrate.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments, as well as specific examples thereof, are intended to encompass equivalents thereof.

The following aspects are disclosed:
1. A system for thermal cycle counting, comprising: a passive thermal sensor configured to detect an occurrence of thermal cycles, and to record a cumulative count of thermal cycles via alteration of an electrical property of the thermal sensor, wherein each alteration of the electrical property is non-transient; a reader configured to measure the electrical property of the thermal sensor, and to generate a signal based on the measured electrical property; and a communication interface configured to transmit the signal to a host controller.
2. The system of aspect 1, further comprising a local controller configured to process the signal from the reader to generate an encrypted signal, and wherein the communication interface is configured to transmit the encrypted signal to the host controller.
3. The system of aspect 2, wherein the local controller comprises a physical unclonable function, PUF, unit configured to generate a unique encryption value based on a physical property of the PUF unit, and to modify the signal based on the unique encryption value to generate the encrypted signal.
4. The system of any of aspects 1-3, further comprising a processing unit configured to process the signal to determine thermal cycle data including the cumulative count of the thermal cycles.
5. The system of aspect 4, wherein the thermal sensor is placed in proximity to a component to be monitored, and wherein the processing unit is configured to analyse the thermal cycle data to generate component data describing a condition of the component.
6. The system of aspect 5, wherein the processing unit is configured to analyse the thermal cycle data using a machine-learning algorithm trained to receive thermal cycle data and output component data based on the received thermal cycle data.
7. The system of aspect 5 or 6, wherein the processing unit is configured to analyse the thermal cycle data based on a digital twin model configured to emulate behaviour of the component.
8. The system of any of aspects 5-7, wherein the processing unit is further configured to process the component data to identify one or more faults of the component.
9. The system of any of aspects 4-8, wherein either: the system further comprises the host controller configured to receive the signal from the communication interface, and the processing unit is provided as part of the host controller; or the system further comprises a local controller, and the processing unit is provided as part of the local controller.
10. The system of any of aspects 4-9, further comprising a memory unit configured to store the determined thermal cycle data.
11. The system of any of aspects 1-10, wherein the communication interface is further configured to receive an instruction from the host controller to initiate reading of the electrical property by the reader.
12 The system of aspect 11, further comprising a local controller configured, responsive to the communication interface receiving the instruction, to control the reader to generate the signal.
13. The system of any of aspects 1-12, wherein the communication interface comprises a wired connection to the host controller via which the communication interface is configured to transmit the signal.
14. The system of any of aspects 1-13, wherein the communication interface comprises a wireless transmitter via which the communication interface is configured to transmit the signal to the host controller.
15. The system of any of aspects 1-14, further comprising a power harvesting module configured to obtain power for the reader, and/or communication interface. v16. The system of aspect 15, wherein the power harvesting module is configured to generate the power using ambient thermal energy.
17. The system of aspect 16, wherein the power harvesting module is configured to receive power from the host controller.
18. The system of any of aspects 15-17, further comprising an energy storage device configured to store the obtained power for the reader and/or the communication interface.
19. The system of any of aspects 1-18 further comprising a power management unit configured to control power provided to the reader and/or the communication interface.
20. The system of any of aspects 1-19, further comprising a casing configured to house the thermal sensor, reader, and/or communication interface.
21. The system of aspect 20, wherein the casing is hermetically sealed.
22. The system of aspect 20 or 21, further comprising a thermal conduit configured to transfer heat from outside the casing to the thermal sensor.
23. The system of any of aspects 1-22, further comprising a plurality of passive thermal sensors, each configured to detect an occurrence of thermal cycles; and record a cumulative count of thermal cycles via alteration of an electrical property of the respective thermal sensor, wherein each alteration of the electrical property is non-transient, and wherein the reader is configured to measure the electrical property of each thermal sensor, and to generate the signal based on the measured electrical property of each thermal sensor.
24. The system of any of aspects 1-23, wherein the thermal sensor is a diffusion-based sensor, wherein alteration of the electrical property is associated with localized diffusion of a diffusant within the diffusion-based sensor in response to exposure of the diffusion-based sensor to a predetermined temperature for a predetermined length of time.
25. A system for monitoring thermal exposure events, comprising: a passive thermal sensor configured to detect an occurrence of thermal exposure events, and record the occurrence of the thermal exposure event via alteration of an electrical property of the thermal sensor, wherein each alteration of the electrical property is non-transient; a reader configured to measure the electrical property of the thermal sensor, and to generate a signal based on the measured electrical property; a local controller configured to process the signal to generate an encrypted signal; and a communication interface configured to transmit the encrypted signal to a host controller for processing the encrypted signal.
26. The system of aspect 25, wherein the local controller comprises a physical unclonable function, PUF, unit configured to generate a unique encryption value based on a physical property of the PUF unit, and to modify the signal based on the unique encryption value to generate the encrypted signal.
27. The system of aspect 25 or 26, wherein the thermal exposure events are thermal cycles, wherein the passive thermal sensor is configured to detect an occurrence of thermal cycles, and to record a cumulative count of thermal cycles via alteration of an electrical property of the thermal sensor, and wherein each alteration of the electrical property is non-transient
28. The system of aspect 27, further comprising a processing unit configured to process the signal to determine thermal cycle data including the cumulative count of the thermal cycles.
29. The system of any preceding aspect, wherein the thermal sensor is placed in proximity to a component to be monitored, and wherein the processing unit is configured to analyse the thermal exposure event data to generate component data describing a condition of the component.
30. The system of aspect 29, wherein the processing unit is configured to analyse the thermal exposure event data using a machine-learning algorithm trained to receive thermal exposure event data and output component data based on the received thermal exposure event data.
31. The system of aspect 29 or 30, wherein the processing unit is configured to analyse the thermal exposure event data based on a digital twin model configured to emulate behaviour of the component.
32. The system of any of aspects 29-31, wherein the processing unit is further configured to process the component data to identify one or more faults of the component.
33. The system of any of aspects 29-32, wherein either: the system further comprises the host controller configured to receive the signal from the communication interface, and the processing unit is provided as part of the host controller; or the system further comprises a local controller, and the processing unit is provided as part of the local controller.
34. The system of any of aspects 29-33, further comprising a memory unit configured to store the determined thermal exposure event data.
35. The system of any of aspects 25-34, wherein the communication interface is further configured to receive an instruction from the host controller to initiate reading of the electrical property by the reader.
36. The system of aspect 35, further comprising a local controller configured, responsive to the communication interface receiving the instruction, to control the reader to generate the signal.
37. The system of any of aspects 25-36, wherein the communication interface comprises a wired connection to the host controller via which the communication interface is configured to transmit the signal.
38. The system of any of aspects 25-37, wherein the communication interface comprises a wireless transmitter via which the communication interface is configured to transmit the signal to the host controller.
39. The system of any of aspects 25-38, further comprising a power harvesting module configured to obtain power for the reader, and/or communication interface.
40. The system of aspect 39, wherein the power harvesting module is configured to generate the power using ambient thermal energy.
41. The system of aspect 40, wherein the power harvesting module is configured to receive power from the host controller.
42. The system of any of aspects 39-41, further comprising an energy storage device configured to store the obtained power for the reader and/or the communication interface.
43. The system of any of aspects 25-42 further comprising a power management unit configured to control power provided to the reader and/or the communication interface.
44. The system of any of aspects 25-43, further comprising a casing configured to house the thermal sensor, reader, and/or communication interface.
45. The system of aspect 44, wherein the casing is hermetically sealed.
46. The system of aspect 44 or 45, further comprising a thermal conduit configured to transfer heat from outside the casing to the thermal sensor.
47. The system of any of aspects 25-46, further comprising a plurality of passive thermal sensors, each configured to detect an occurrence of thermal cycles; and record a cumulative count of thermal cycles via alteration of an electrical property of the respective thermal sensor, wherein each alteration of the electrical property is non-transient, and wherein the reader is configured to measure the electrical property of each thermal sensor, and to generate the signal based on the measured electrical property of each thermal sensor.
48. The system of any of aspects 25-47, wherein the thermal sensor is a diffusion-based sensor, wherein alteration of the electrical property is associated with localized diffusion of a diffusant within the diffusion-based sensor in response to exposure of the diffusion-based sensor to a predetermined temperature for a predetermined length of time.

What is claimed is:

1. A system for thermal cycle counting, comprising:
a passive thermal sensor configured to detect an occurrence of thermal cycles, and to record a cumulative count of thermal cycles via alteration of an electrical property of the thermal sensor, wherein each alteration of the electrical property is non-transient;
a reader configured to measure the electrical property of the thermal sensor, and to generate a signal based on the measured electrical property; and
a communication interface configured to transmit the signal to a host controller.

2. The system of claim 1, further comprising a local controller configured to process the signal from the reader to generate an encrypted signal, and wherein the communication interface is configured to transmit the encrypted signal to the host controller.

3. The system of claim 2, wherein the local controller comprises a physical unclonable function (PUF) unit configured to generate a unique encryption value based on a physical property of the PUF unit, and to modify the signal based on the unique encryption value to generate the encrypted signal.

4. The system of claim 1, further comprising a processing unit configured to process the signal to determine thermal cycle data including the cumulative count of the thermal cycles.

5. The system of claim 4, wherein the thermal sensor is placed in proximity to a component to be monitored, and wherein the processing unit is configured to analyse the thermal cycle data to generate component data describing a condition of the component.

6. The system of claim 5, wherein the processing unit is configured to analyse the thermal cycle data using a machine-learning algorithm trained to receive thermal cycle data and output component data based on the received thermal cycle data.

7. The system of claim 5, wherein the processing unit is configured to analyse the thermal cycle data based on a digital twin model configured to emulate behaviour of the component.

8. The system of claim 5, wherein the processing unit is further configured to process the component data to identify one or more faults of the component.

9. The system of claim 4, wherein either: the system further comprises the host controller configured to receive the signal from the communication interface, and the processing unit is provided as part of the host controller; or the system further comprises a local controller, and the processing unit is provided as part of the local controller.

10. The system of claim 1, wherein the communication interface is further configured to receive an instruction from the host controller to initiate reading of the electrical property by the reader.

11. The system of claim 1 wherein the communication interface comprises a wired connection to the host controller via which the communication interface is configured to transmit the signal.

12. The system of claim 1, wherein the communication interface comprises a wireless transmitter via which the communication interface is configured to transmit the signal to the host controller.

13. The system of claim 1, further comprising a power harvesting module configured to obtain power for the reader, and/or communication interface.

14. The system of claim 13, wherein the power harvesting module is configured to generate the power using ambient thermal energy.

15. The system of claim 13, wherein the power harvesting module is configured to receive power from the host controller.

16. The system of claim 1, further comprising a power management unit configured to control power provided to the reader and/or the communication interface.

17. The system of claim 1, further comprising a casing configured to house the thermal sensor, reader, and/or communication interface.

18. The system of claim 1, further comprising a plurality of passive thermal sensors, each configured to:
detect an occurrence of thermal cycles;
record a cumulative count of thermal cycles via alteration of an electrical
property of the respective thermal sensor, wherein each alteration of the electrical property is non-transient, and wherein the reader is configured to measure the electrical property of each thermal sensor; and
generate the signal based on the measured electrical property of each thermal sensor.

19. The system of claim 1, wherein the thermal sensor is a diffusion-based sensor, wherein alteration of the electrical property is associated with localized diffusion of a diffusant within the diffusion-based sensor in response to exposure of the diffusion-based sensor to a predetermined temperature for a predetermined length of time.

20. A system for monitoring thermal exposure events, comprising:
a passive thermal sensor configured to detect an occurrence of thermal exposure events, and record the occurrence of the thermal exposure event via alteration of an electrical property of the thermal sensor, wherein each alteration of the electrical property is non-transient;
a reader configured to measure the electrical property of the thermal sensor, and to generate a signal based on the measured electrical property;
a local controller configured to process the signal to generate an encrypted signal; and
a communication interface configured to transmit the encrypted signal to a host controller for processing the encrypted signal.
